(19) United States
(12) Patent Application Publication
(10) Pub. No.: US 2016/0247107 A1
(43) Pub. Date: Aug. 25, 2016

(54) CUSTOMIZABLE HIERARCHICAL WORKSPACE SYSTEM FOR COLLABORATION AND REVENUE DISTRIBUTION, IN SERVICING REQUESTS ON A COMPUTING PLATFORM

(71) Applicant: Kemp Ingram Simon, Toronto (CA)

(72) Inventor: Kemp Ingram Simon, Toronto (CA)

(21) Appl. No.: 15/049,406

(22) Filed: Feb. 22, 2016

(30) Foreign Application Priority Data
Feb. 23, 2015 (CA) 2882486

(51) Int. Cl. G06Q 10/06; G06Q 10/10

(52) U.S. Cl. CPC G06Q 10/06313; G06Q 10/103

(57) ABSTRACT

A hierarchically structured and customizable business system, for computing platforms accommodating service requesters and collaborating service providers, whereby in preferred embodiments, for fixed-price projects, revenue distribution is streamlined, in accordance with the participation of these collaborators and in support of their integration and development. Operationally, for each fixed-price service provided, the revenue generated is allocated in diminishing proportions to levels for service provision, service coordination, operational funding and shareholding. At the service provision level, earnings are based on individual contributions to various project roles and service tasks. At the service coordination level, earnings vary in association with relative oversight values. Market intelligence guides controls on service provider recruitment, to better facilitate their engagement and development. Minimal collaboration prescriptions support novices, but otherwise choice collaboration predominates. Semi-independent service provider promotions to semi-independent service coordinator positions are performance based.

### BRIEF DESCRIPTION

1. Field of the Invention

The invention relates to the application of information and communication technology to a semi-open source business system for servicing requests, with emphasis on service provider integration, collaboration and development and as an alternative to prevalent open-source business systems.

2. Background

Business model evolution is a natural consequence of the advances in information and communication technology, as is evident in the prevalence of open-source or decentralised market services which are expanding access to service provision. Nevertheless, challenges remain as for example, in support of the Digital Agenda for Europe, the European Commission has been seeking information and new ideas relating to the enabling of job growth by information and communications technology (ICT). Somewhat related to this job growth challenge is the facilitation of entry level employment, primarily in sophisticated sectors, as companies seek to maximise efficiencies and as skill needs change in response to new innovation and market evolution. An Eco Canada (2010) report and periodic media reports and media discussions have referred to these challenges to worker integration and development.

Society will be well served by decentralised market services that support choice engagements and the integration and development of its participants, while remaining an effective competitor in the facilitation of service provision. Critical to the establishment of such decentralised service are structural support, the conglomeration of interrelated skills, enhanced collaboration, development opportunities and the mitigation of remuneration risks. Although some decentralised markets have been providing some support to the aggregation, of niche services, their roles remain limited, as they currently lack the added benefits that minimal hierarchies can provide to facilitate standardised outputs and support professional assimilation and development, primarily in the provision of sophisticated services. Decentralised market services are also deficient in structures that provide significant support for skill development and skill evolution and that can aggregate the material resources essential for providing aspects of sophisticated services.

Minimal hierarchical structures incorporated into marketplaces for professional services can enhance the quality and reliability of service provision and diminish the need to have service requesters manage service provision, primarily in sophisticated areas of work. Minimal hierarchies can add a project or service coordination level that can guide and quality control service provision and a revenue accumulation unit to pool operational cost for software services, operating equipment and limited office accommodation and with these facilities contribute to the expansion of service delivery.

Decentralised markets often provide payment mechanisms, but they have also not optimised revenue distribution among collaborating teams to facilitate impartiality and improve the mitigation of remuneration risk. For fixed price projects, billed time presents challenges to the objective compensation of collaborating individuals, more so where these collaborators have a wide variety of skills and variation in skill levels, while arbitrary agreements of percentage compensations for portions of work done can be self-serving. The incorporation of universally applied task valuation methodologies can better serve collaboration on fixed-priced project work in semi-open source markets.

### SUMMARY OF THE INVENTION

The computer implemented semi-open source hierarchical workspace invention targets sector focused collaboration on a platform structured to organise individuals to function at levels at which most participants are at least periodically assimilated into some aspect of service provision, even as choice collaboration predominates. This entails fostering the growth and development of service providers, through minimum novice inclusivity prescriptions and through performance based promotional opportunities. Consequently, semi-independent service providers participating in this hierarchical workspace negotiate, supervise and execute projects which are coordinated by more experienced participants. The semi-independence of these service providers and coordinators relates to their voluntary participation in projects and their compensation directly connected with personal production on a per-project basis, all subject to the participation, collaboration and revenue distribution rules of the hierarchical workspace. Service providers may qualify for promotion to these coordinator positions in which they will oversee multiple projects. Project oversight and skill improvement through guidance serve to ensure quality outputs and timeliness as a group responsibility.

In effect the hierarchical workspace is a semi-open source for projects and services that accommodates same-sector service providers operating in persisting groups and transient sub-groups, in various sub-sector focus areas. The semi-open nature involves entry controls, guided by automated assessments of the potential for new recruits to become reasonably engaged in the short term. This entry into the hierarchical workspace will be from a mix of queueing, competition and project needs.

For each project, the hierarchical workspace system has revenue allocations declining at progressively higher levels, commencing from service provision and advancing to service coordination, operational funding and shareholding, where each revenue allocation constrains the funds distributed to compensate individuals. Nevertheless, fewer individuals function at the higher levels, consequently for multiple projects involving different lower-level participants, individual incomes increase at higher hierarchy levels.

At the service provision level, individual compensation is assessed from activity weights and the task fractions contributed to project or service negotiation, supervision and/or execution. At the project or service coordination level compensation is based on the coordinators' personal project or service oversight values. Service provider and project coordinator compensations are further adjusted for regional costs of living differences, to preserve equity in the spending value of the incomes distributed to dispersed collaborators. The operating fund allocation facilitates shared costs for software services, operating equipment and limited office accommodation.

In another aspect of the invention, as a strategy to incentivise project sourcing, the service provider's compensation for negotiating projects is enhanced as project scarcity increases and incomes decrease.

### BRIEF DESCRIPTION OF THE DRAWINGS

The hierarchical workspace process, is described in modules, each associated with an aspect of the innovated algorithm, hence figure numbers align with those of relevant components of this underlying algorithm e.g. FIGS. 1A and 1B are associated with the algorithm component in FIG. 1, while FIGS. 3A and 3B are associated with the algorithm component in FIG. 3.

FIG. 1 has the revenue distribution hierarchy algorithm component.

FIG. 1A represents the innovated hierarchical workspace, with occupancy levels and revenue fractions for allocating project income to the various hierarchy levels for specific purposes.

FIG. 1B has a description of the process innovated for assigning revenue fractions to levels in the hierarchical workspace.

FIG. 1C is a plot of revenue fractions generated with the hierarchical workspace configured for 4 levels with the power parameter α=1.0 and the level fraction LF≈0.306.

FIG. 1D is a table of the revenue fractions and the revenue generated for an assumed project income value of $100,000.00 and with the hierarchical workspace configured for 4 levels with α=1.0 and LF≈0.343.

FIG. 1E is a plot of revenue fractions generated with the hierarchical workspace configured for 5 levels and with α=1.0 and LF=0.336.

FIG. 1F is a plot of revenue fractions generated with the hierarchical workspace configured for 4 levels and with α=0.723 and LF≈0.178.

FIG. 2 has the algorithm component for specifying recruitment numbers to optimise participation numbers.

FIG. 2A depicts the process innovated to estimate the admissible number of service providers.

FIG. 2B is a plot of the number of potential recruits, influenced by earnings and project availability.

FIG. 2C is a plot of the number of potential recruits influenced only by the earning component.

FIG. 2D is a plot of the number of potential recruits influenced only by the project availability component.

FIG. 2E is a table of the simulated relationship between the number of coordinators allowed given the number of service providers listed.

FIG. 3 has the algorithm component that evaluates the service providers' performance evaluations.

FIG. 3A describes the process innovated for obtaining the service values that determine the eligibility of service providers for promotion.

FIG. 3B is a table of simulated service values, required to determine the eligibility of the service providers referred to in FIG. 4D for promotion.

FIG. 4 has the revenue distribution algorithm component for service provision.

FIG. 4A displays a simplified project negotiation, supervision, and execution interaction applicable at the lowest level of the hierarchy.

FIG. 4B describes the process innovated for utilizing service fractions and project weights to distribute service incomes to collaborating service providers working on fixed-price projects.

FIG. 4C describes the process innovated for generating the service fractions that determine the service incomes of collaborating service providers working on fixed-price projects.

FIG. 4D is a table of simulated non-regionalised and regionalised service incomes at the lowest level of the hierarchy, for 3 collaborating service providers each resident in a different economic region.

FIG. 4E is a plot which compares the non-regionalized and regionalised service incomes for 3 service providers performing similar tasks.

FIG. 4F is a table displaying the simulated non-regional service fractions generated for service negotiation, supervision, and execution, and utilised to generate the service incomes in FIG. 4D.

FIG. 4G is a table of the derived activity weights that combine with the task fractions to generate the service fractions in FIG. 4F.

FIG. 4H is a table of the standard activity weights utilized to generate the activity weights in FIG. 4G.

FIG. 4I is a table of the task fractions which were also utilized in the generation of the service fractions in FIG. 4F.

FIG. 5 has the project weight algorithm component for service revenue distribution.

FIG. 5A describes the process innovated for generating project weights that vary with project availability and earnings.

FIG. 5B is a plot of the variation of project weights for negotiation, supervision, and execution, with the lower quartile of service provider earnings.

FIG. 5C is another plot of the variation of project weights for negotiation, supervision and execution, with the lower quartile of service provider earnings, but with less projects available.

FIG. 5D is a plot of the project weight responses to the unfulfilled recruitment needs in FIG. 2B.

FIG. 6 is the revenue distribution for project coordination algorithm component.

FIG. 6A indicates the process innovated for assigning coordinator income on the basis of their project oversight and performance.

FIG. 6B is a table of simulated regionalised and non-regionalised coordinators' incomes earned overseeing aspects of projects, as assumed.

FIG. 7 has the project weight algorithm component for service revenue distribution.

FIG. 7A shows the preferred share divisions between franchisers and franchisees, the latter being service group founders and service coordinators.

FIG. 7B displays the simulated share fractions, of 4 service coordinators over a 21, year period

FIG. 7C displays the simulated share income, of 4 service coordinators over a 21 year period.

### DETAILED DESCRIPTION OF THE PRESENTLY PREFERRED EMBODIMENTS

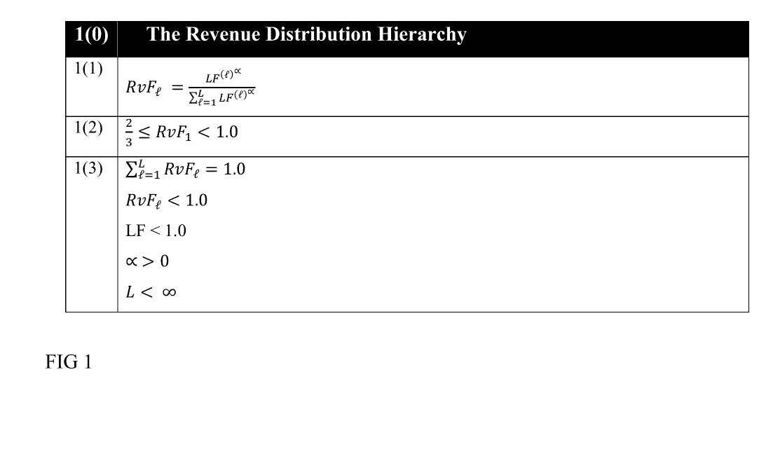

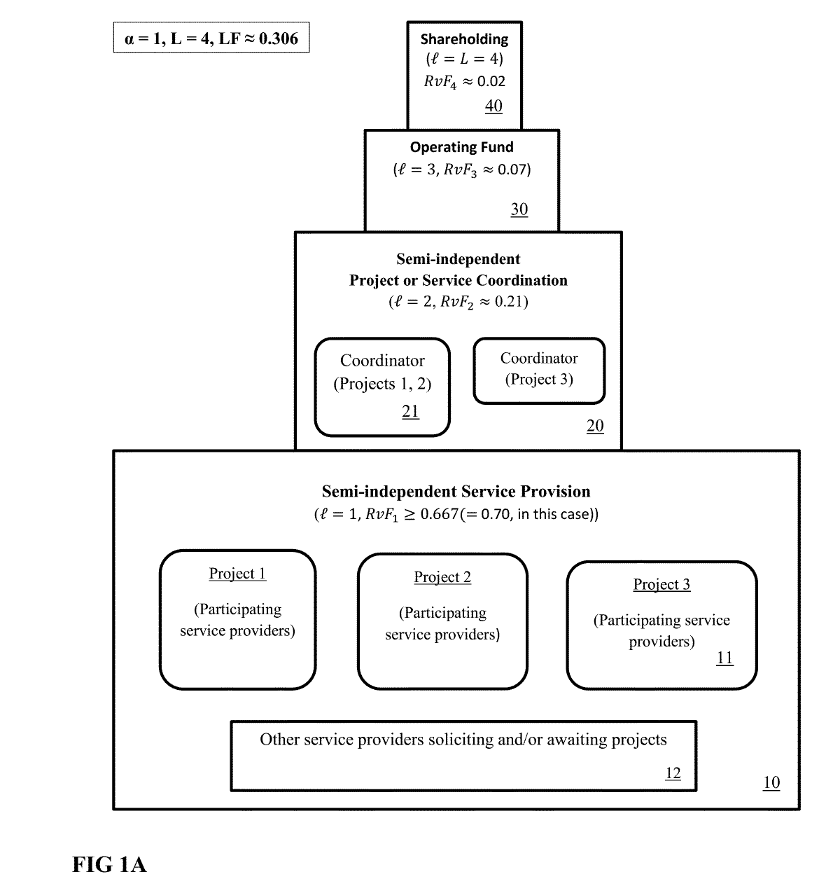

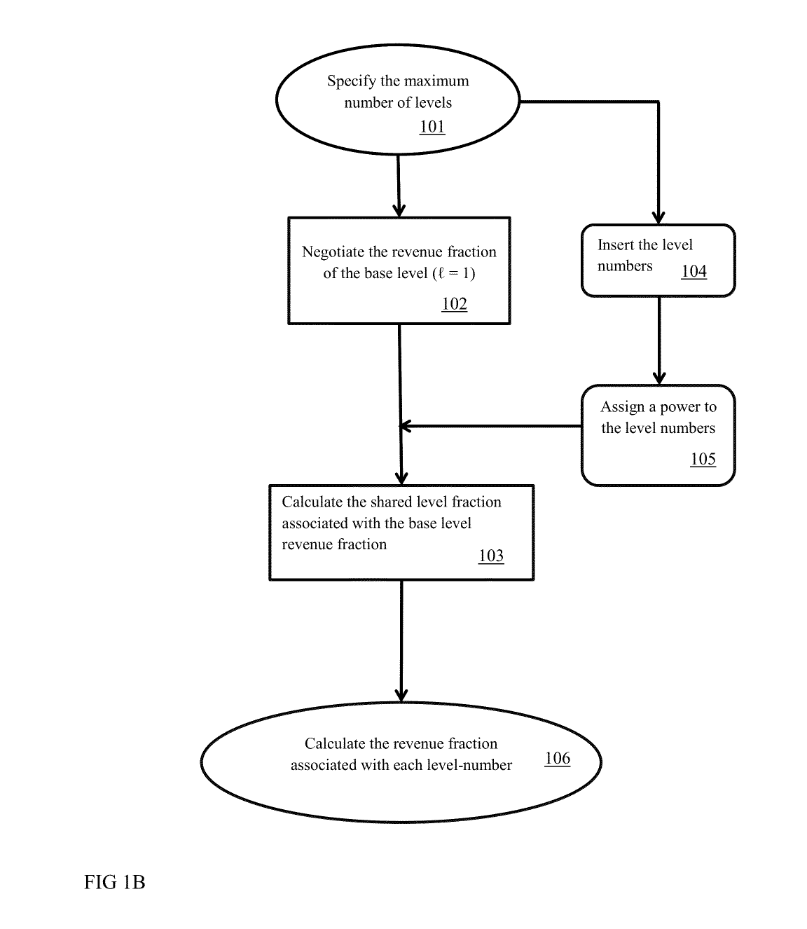

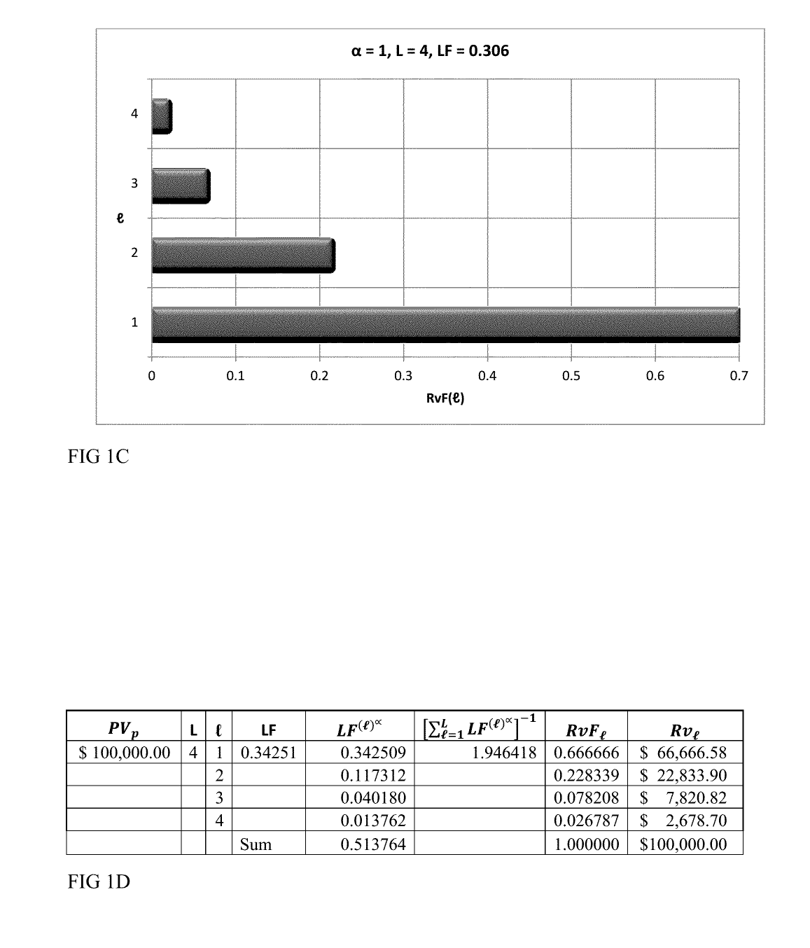

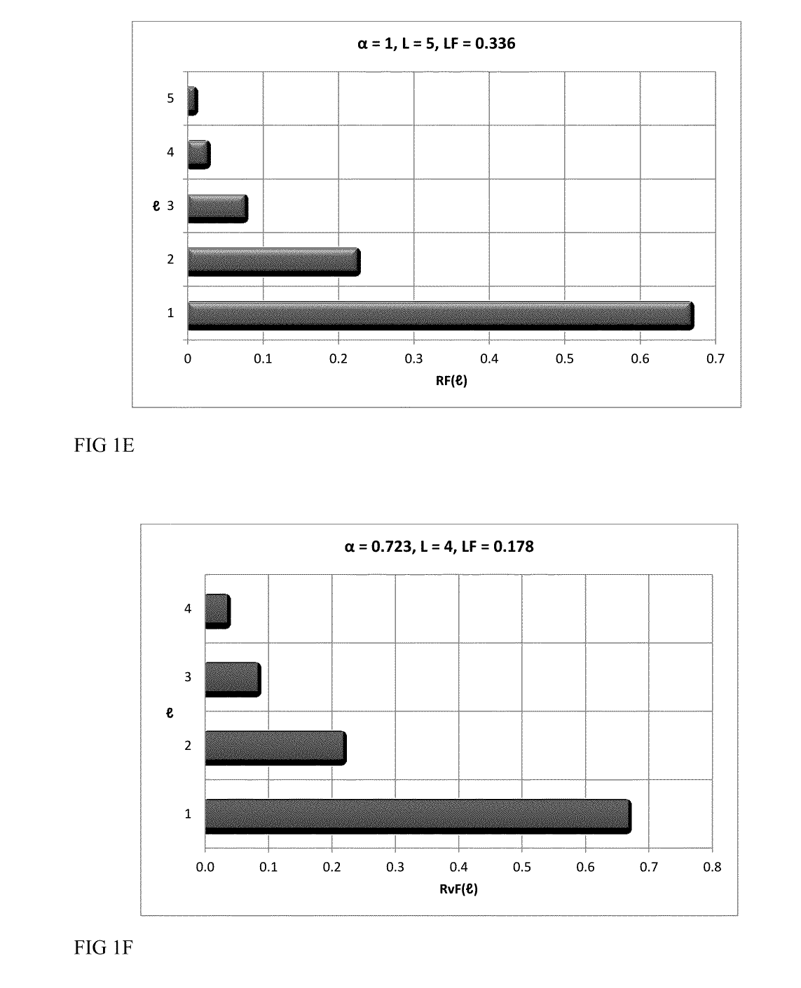

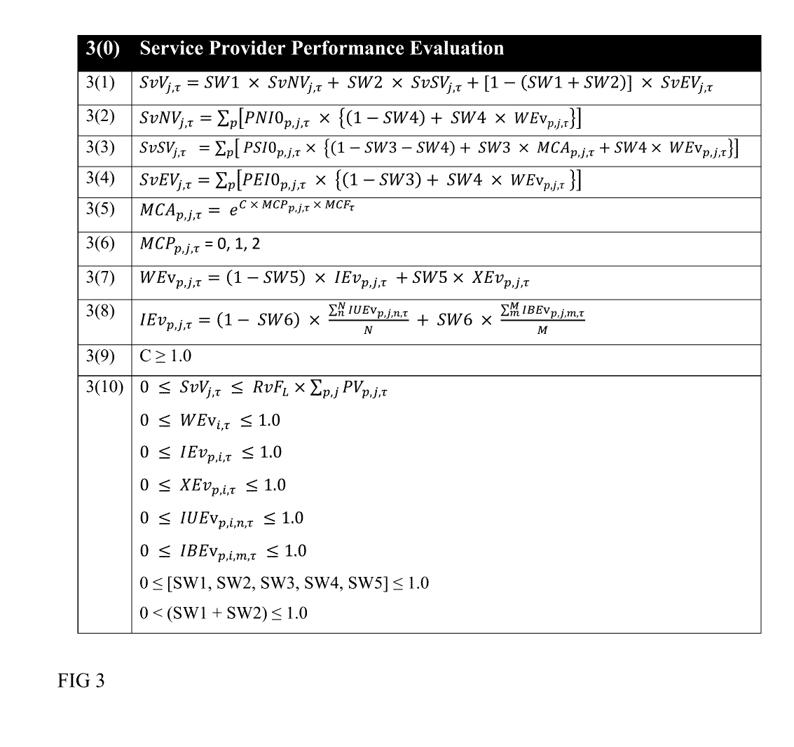

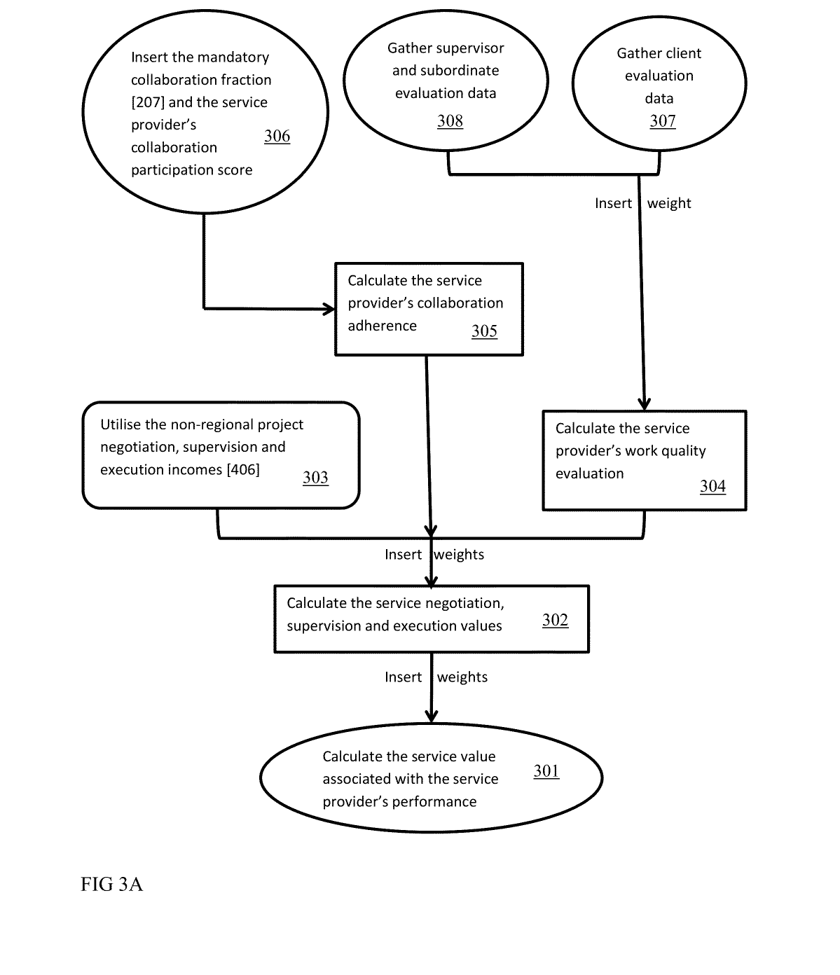

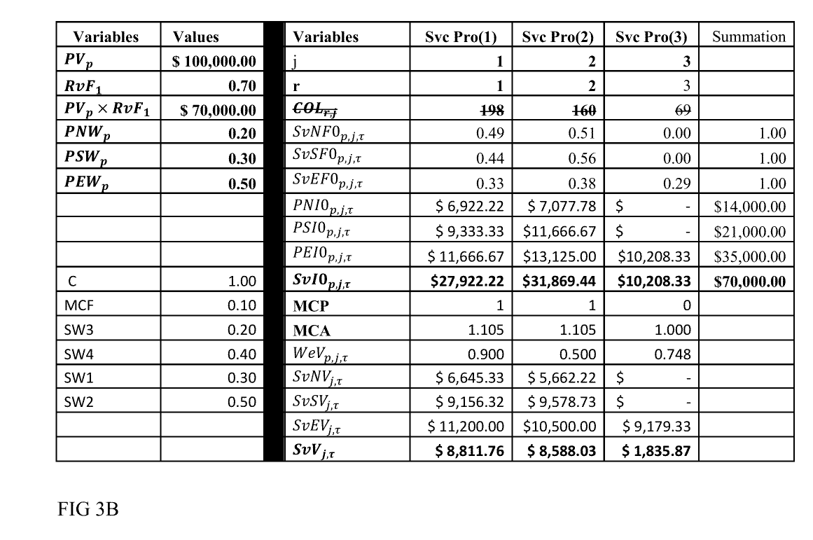

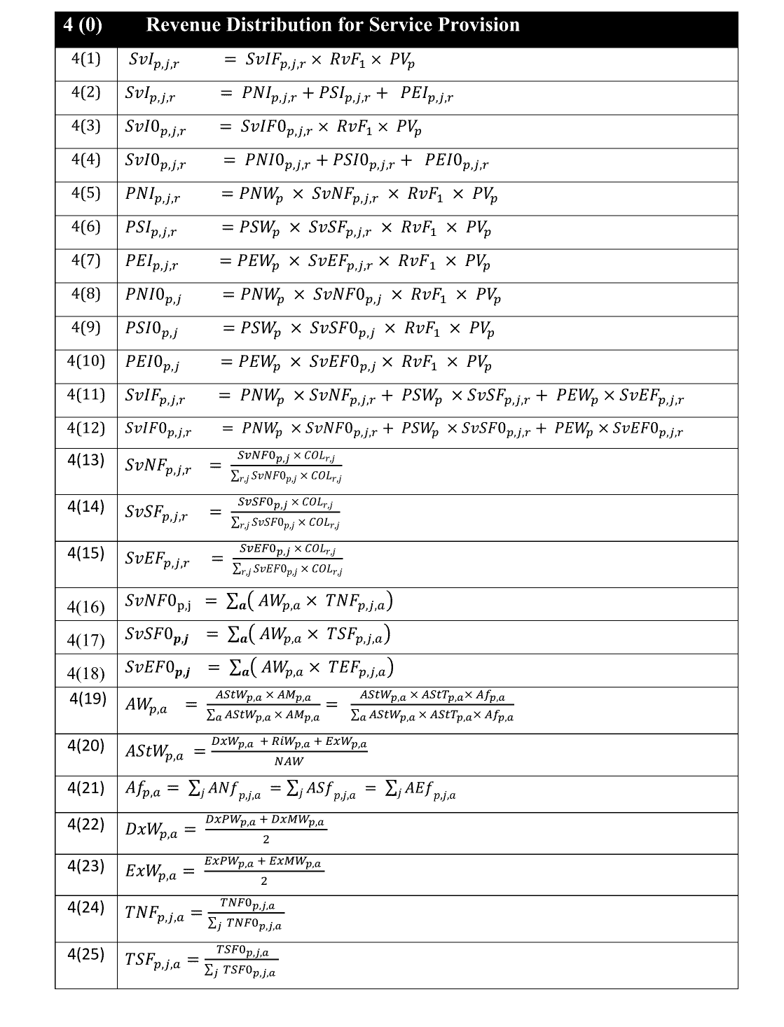

The hierarchical workspace system is a computer implemented process, described in modules, each associated with an aspect of the innovated algorithm, hence figure numbers correspond with the numbers assigned to relevant components of this underlying algorithm e.g. FIG. 1A and FIG. 1B are associated with algorithm component in FIG. 1 while FIG. 3A is associated with algorithm component in FIG. 3. For convenience and effectiveness, descriptions may commence from the end point or from the beginning of any given flow chart representing a module. Within each such module flow the underlined numbers assigned to elements of the process increase as they follow the descriptions. Inter flow-chart processes are identified by square-bracketed numbers.

### The Revenue Distribution Hierarchy

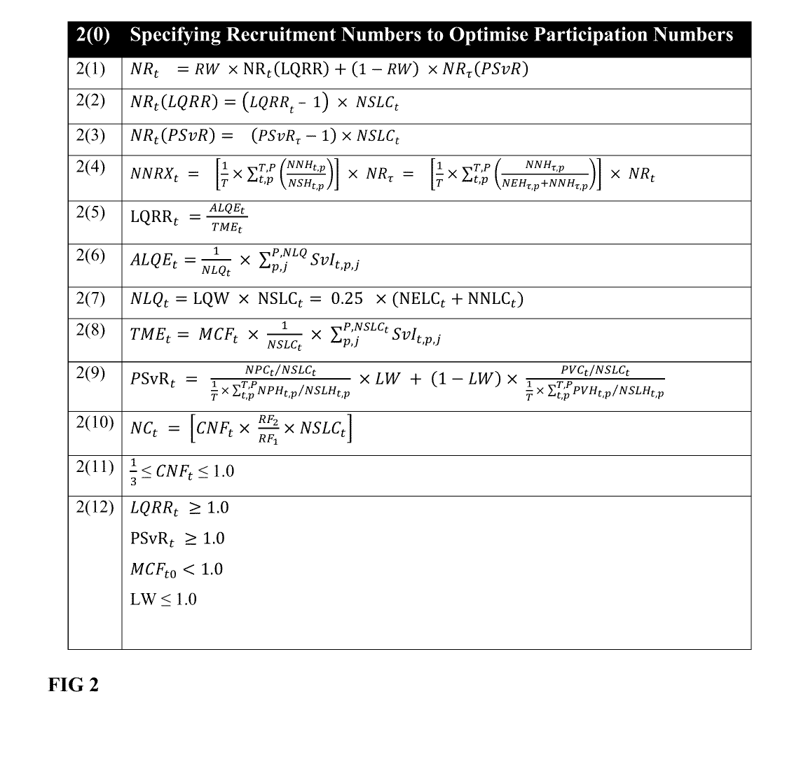

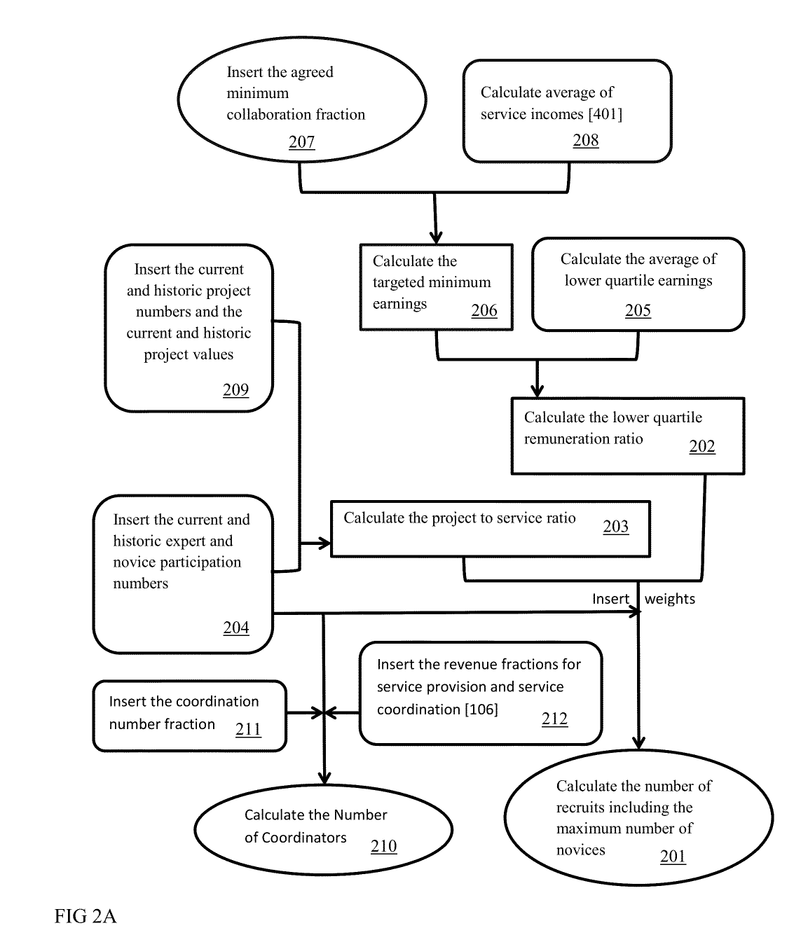

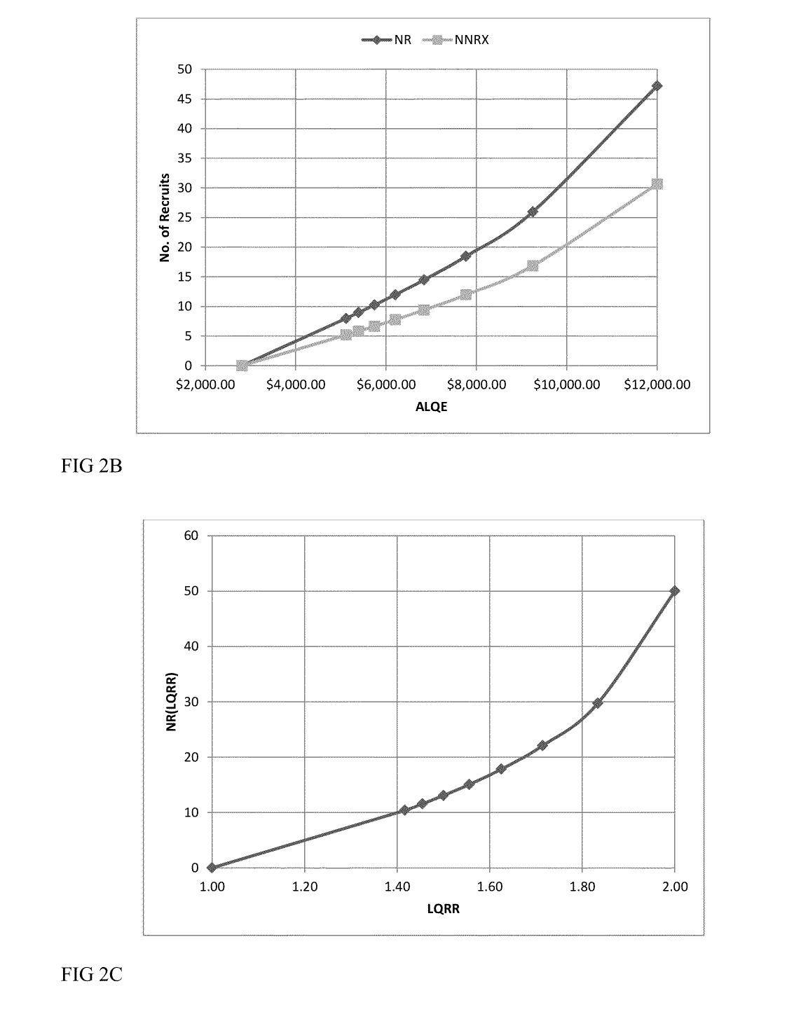

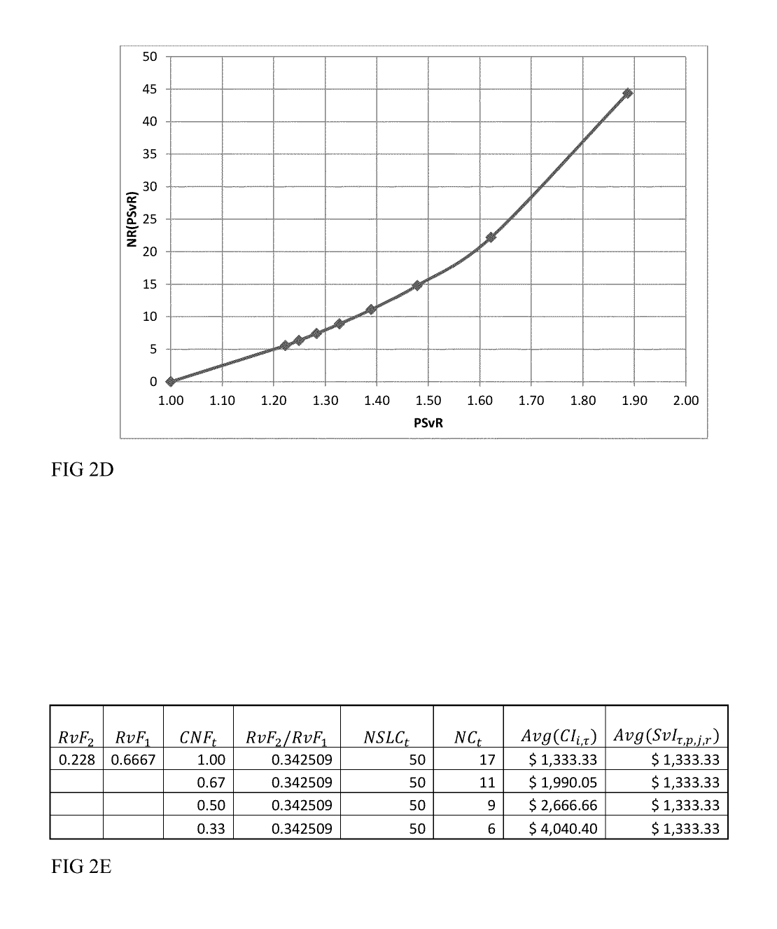

The hierarchical workspace invention fosters transparency and consistency in the distribution of revenue generated in service provision. Rvenue fractions constrain revenue distribution at each hierarchy level as these revenue fractions, and where they exist participant numbers, decline at higher levels. Each project may involve a different group of service providers, resulting with fewer higher level service coordinators, each having multiple project engagements. Consequently, for a single project, the total income allocated to participants decreases at higher levels, but for multiple projects this total income trend is inverted. The revenue fractioning at hierarchy levels is based on the module, FIG. 1, of an innovated algorithm, that together with its accompanying modules, FIGS. 2, 3, 4, 5, 6, 7 facilitate hierarchical workspace automation.

FIG. 1A depicts the revenue distribution levels, l, totaling, L, innovated for this hierarchical workspace system. Here, these levels commence from l=1 at the base and are sequentially indexed to a maximum l=4 at the top. As the numbers assigned to the levels increase, the revenue fraction, RvFₗ (FIG. 1(l)), assignments decline, giving in this specific case, RvF₁ (≈0.70)>RvF₂ (≈0.21)>RvF₃ (≈0.07)>RvF₄ (≈0.02). The revenue fractions determine the allocation of the total project values (incomes) after expenses toward service provision at l=1 (FIG. 1A, 10), project, or service coordination at, l=2 (20), operation funding at, l=3 (30), and shareholding at, l=L=4 (40). At the level l=1 (10), the service providers may be participating in a project (11), or soliciting and/or awaiting projects (12), while at l=2 (20) the coordinators (21) may be coordinating one or more projects, or otherwise seeking projects to coordinate.

FIG. 1B is a flow chart of the process invented for evaluating revenue allocations to levels in the hierarchical workspace, while FIG. 1C to FIG. 1F demonstrate its application. As innovated, this RvFₗ (FIG. 1(1)) structure has a number of levels, L (FIG. 1B, 101), the first being the base level, l=1, at which the largest revenue fraction, RvF₁ (102) extracts the largest proportion of the project value after expenses. A shared level fraction (103), LF (<1), powered by the level number, l (104), the latter elevated to a power α (105), is then utilised to generate the revenue fractions (106) RvFₗ (FIG. 1(1)) of each level. These revenue fractions decline progressively as the level numbers increase. The numbering of levels in association with revenue fractions is a convenience which, in other embodiments, may be reversed or avoided in descriptions of equivalent structures.

Hierarchical workspace management negotiates the base-level, or service provision revenue fraction, RvF₁, with service providers as a group, and this RvF₁ is then set for all projects done in a given period of time. As a boundary and guide to this negotiation, for preserving fairness in compensating service providers, the base-level revenue fraction has the limitation RvF₁≧0.667, for all values of the configuring variables, L, LF and a. This RvF₁≧0.667 is a value set by considering the non-base levels as a management block, for coordination, operational funding and shareholding, with 1 functional superior, as assumed, overseeing a minimum of 2 subordinates in the service provision block, and with equivalent revenue sharing among these individuals, as a fairness prescription. With this assumption, any added subordinate increases the revenue allocated to the management block above that of the subordinate or base level.

The hierarchical workspace system can be customized to compromise the needs of service providers, management and shareholders. As indicated above, the revenue proportions assigned to levels of the hierarchical workspace system can be adjusted by changing at least 1 of 3 parameters i.e. L, LF and/or α, and these changes will impact the entire system while conserving revenue. The parameter L, changes the number of levels, while LF sets the base-level revenue fraction, RvF₁, connected with service provider compensation and, α, skews the revenue fraction profile to enhance either its lower level (FIG. 1A) or its upper level values. The revenue fractions adjust slightly to accommodate any number of added levels and as a consequence, theoretically there can be a near infinite number, L, of levels, however with RvF₁>0.667, then as L increases the smallest revenue fraction, RvF_{L}, located at the highest level, as designed, rapidly approaches zero, effectively limiting the number of levels, in practical applications.

Preferred is the α=1.0 hierarchical workspace embodiment, with RvF₁≧0.667 and L≧4, where, at the base level, l=1, the revenue fraction, RvF₁, compensates service provision, while at progressively higher levels, RvF₂, compensates service coordination, RvF₃, accumulates the operational funds, and RvF₄ to RvF_{L}, compensate shareholders. As l increases with departure from the RvF₁ base value, this α=1.0 configuration produces reasonable RvFₗ decreases at all levels, although with RvF₁ unchanged, an increase in the number, L, of levels accelerates the RvFₗ diminutions, primarily at higher levels, to facilitate the added level(s). As a result of these characteristics, adding levels with the aggregation of the uppermost and adjacent revenue fractions is a preferred means of accelerating investor returns, with minimal impact on revenue fractions at the non-shareholding levels.

FIG. 1C is a plot of revenue fractions, RvFₗ (FIG. 1B, 106 and FIG. 1(l), generated for levels numbered, l, with the α=1.0, L=4, LF≈0.306, hierarchical workspace configuration. As the level numbers increase, the generated revenue fractions, RvFₗ, decline, commencing from service provision RvF₁≈0.70 and advancing to project or service coordination RvF₂≈0.21, operation funding RvF₃≈0.07, and shareholding RvF₄≈0.02.

FIG. 1D provides revenue fractions, RvFₗ (FIG. 1B, 106 and FIG. 1(l)), and the associated revenue, Rvₗ, allocated to levels numbered, C, connected with an assumed project value, PVₚ (=$100,000.00), for a hierarchical workspace configured by variables α=1.0, L=4 and LF≈0.343 giving, RvF₁≈0.667, RvF₂≈0.228, RvF₃≈0.078, and RvF₄≈0.027.

In other embodiments, with L>4 the revenue fractions, RvF₃, to RvF_{L}, can be used to facilitate some mix of operation funding and shareholding. In other less favoured embodiments, with L>4, for very large establishments the revenue fraction, RvF₃, may be utilised to remunerate managers of coordinators, while the operating fund is shifted to the higher level of revenue fraction, RvF₄.

FIG. 1E is a plot of revenue fractions, RvFₗ (FIG. 1B, 106 and FIG. 1(l)), generated for levels numbered, l, with the hierarchical workspace configuration α=1.0, L=5, LF=0.336. Comparing these L=5, revenue fractions with those for L=4 in FIG. 1D, here there are, RvF₁≈0.667 (0%), RvF₂≈0.224 (−1.75%), RvF₃≈0.075 (−3.85%), RvF₄≈0.025 (−7.41%), RvF₅=0.009, but RvF₄+RvF₅≈0.034 (+25.93%). The effect of changing from L=4 to L=5 is to reduce the number of coordinators, NCₜ (FIG. 2(10)), by just 2%, approximately. The addition of levels also accelerates the RvFₗ declines at the upper levels. Consequently, adding levels with the aggregation of upper level revenue fractions is a preferred means of accelerating investor returns, with minimal impact on revenue fractions at the non-shareholding levels.

In yet other less favoured embodiments with α≠1.0, setting, α>1.0, skews revenue fractions to enhance their larger or lower-level values, while setting, α<1.0, skews these fractions to enhance their smaller or upper-level values. Changing a skews the hierarchical workspace profile and this significantly enhances the difference between funding capacities at adjacent levels, with notable consequences to inter-level operations.

FIG. 1F is a plot of revenue fractions, RvFₗ (105, FIG. 1(1)), generated for levels numbered, l, with the hierarchical workspace configuration, α=0.723, L=4, LF≈0.178. For this α<1.0 configuration, α and LF were manipulated to achieve the same shareholder returns, RvF₄, as for α=1.0, L=5, LF≈0.336 in FIG. 1E. Comparing these α<1.0 associated revenue fractions, with those for α=1.0 in FIG. 1D, here there are, RvF₁≈0667 (0%), RvF₂≈0.217 (−4.82%), RvF₃≈0.082 (+5.13%), RvF₄≈0.034 (+25.93%). For a 25.93% increase in shareholding benefits, the effect of changing from α=1.0 to α=0.723 is to reduce the number of coordinators, NC (FIG. 2(10)), by as much as 5%, approximately, a value more than twice that obtained when keeping α=1.0 and changing from L=4 to L=5. Changing a skews the hierarchical workspace profile and this can have significant impact on the revenue allocation between levels and on the associated functional capacities.

In the preferred α=1.0, RvF₁≧0.667, L≧4 embodiments, the operating fund derived from the revenue fraction, RvF₃, serves first to defray the cost of running the hierarchical workspace including expenditure for software and other services, but once these costs are met, funds are allocated towards acquisition and maintenance of limited office space and equipment, with these costs shared by hierarchical workspace participants, on a pay as you earn basis.

In these preferred embodiments software and other services are provided at basic operating cost, shared among sector groups. As a basic analysis of this funding capability, the $25 monthly subscription often applied for individual use of project/accounting software equates to approximately 1% of an annual individual income of $30,000.00, then with L=4 and RvF₃≈0.07, this 1% software expenditure leaves the remaining RvF₃≈0.06 for other expenditure.

In less favoured embodiments, with L=3, the shareholding level 4 is removed and profits are derived at the operational funding level 3, from the provision of software and services, above basic cost, or otherwise this can be a non-profit operation with software and services provided at basic cost.

Another feature of the invented hierarchical workspace system, in the preferred profit mode of operation, is the allocation of shares to significant contributors to revenue generation as a shared economy enhancement. Consequently in addition to founders, investors and other shareholding partners, shares are allocated to service coordinators as participating managers. Nevertheless, with α=1.0, L=4, RvF₁≈0.70, in the specific FIG. 1A example, there is the accumulation of revenue fractions RvF₁+RvF₂+RvF₃≈0.98, which has service providers and coordinators as a group benefiting from 98% of the revenue they generate in addition to their shareholding entitlements.

In preferred applications, hierarchical workspace participants operate from geo-fenced groups bound by Geography and service sector. Nevertheless these geo-fenced participants do have options to interact across groups to locate and share clients. In other applications, hierarchical workspace participants may choose to operate in geo-neutral groups, bound only by service sector. Geo-fenced and/or geo-neutral groups generate and manage their own RvF₃ operating fund and their RvF_{L}, shareholding entitlements, in compliance with hierarchical workspace agreements.

### Specifying Recruitment Numbers to Optimise Participation Numbers

In compromising the best interests of shareholders, project coordinators, service requesters and service providers, an objective of the hierarchical workspace invention is to integrate new recruits into project activities and facilitate their career development with minimal impact on choice collaboration and service quality, all aimed for with guidance by artificial intelligence. Consequently, another aspect (FIG. 2) of the innovated algorithm limits recruitment numbers, from among qualified applicants, in association with minimal individual income targets and project availability.

FIG. 2A indicates the process innovated to estimate the number of service providers to be recruited.

For any given short-term period such as one day indexed, t, the permissible number of service provider recruits, NRₜ (FIG. 2A, 201 and FIG. 2(1)), is assessed as a running mean to minimise short-term fluctuations. The short-term NRₜ (201, FIG. 2(1)) value has as its constituents one component, NRₜ(LQRR) (202 and FIG. 2(2)), weighted RW, evaluating income adequacy and another, NRₜ(PSvR) (203 and FIG. 2(3)), evaluating project adequacy.

Qualified applicants enter the hierarchical workspace from a mix of competition, queuing and project needs. A competition queue complements a chronological queue, while eligible service providers with pending and/or active projects are accorded accelerated entry. Experts can leverage the services of novices, who will benefit from this expert guidance, nevertheless the preservation of minimum participation levels internally, requires an upper limit, NNRXₜ (FIG. 2(4); FIG. 2B), on the admission of chronologically queued novices. This novice recruitment ceiling incorporates the reality that each past or historic project involved a total number, NSHₜ (FIG. 2A, 204), of service providers, of which, NNHₜ, were novices or supervised individuals and NEHₜ were experts or unsupervised individuals. The ratios of NNHₜ to NSHₜ values are averaged over the long-term to provide a single value that proportions NRₜ (FIG. 2(1)), to determine NNRXₜ (FIG. 2(4)). This expert and novice labelling, for any given historic project, is specific to the service provider's role in that project, consequently self-supervised participants are also considered transient experts.

For projects numbering, P, the innovated lower quartile remuneration ratio, LQRRₜ (FIG. 2(5)), constituent of NRₜ(LQRR) compares the average income receipts, ALQEₜ (FIG. 2A, 205 and FIG. 2(6)), among the lower quartile of ranked earners numbering NLQₜ (FIG. 2(7)), against a minimum individual earning target, TMEₜ (206 and FIG. 2(8)), set for all service providers currently listed, numbering, NSLCₜ. Here NLQₜ is a proportion or lower quartile weight, LQW (=0.25), of NSLCₜ, the latter being an aggregate of current expert, NELCₜ, and novice, NNLCₜ, listings. In other embodiments LQW may be replaced by other proportions of NSLCₜ.

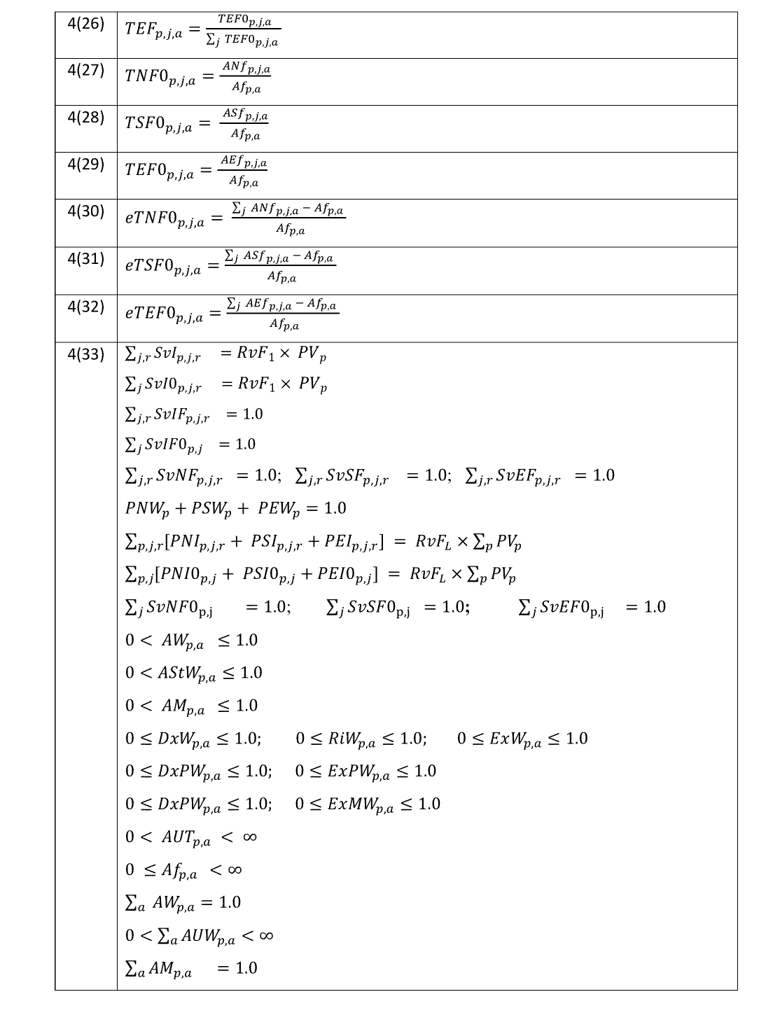

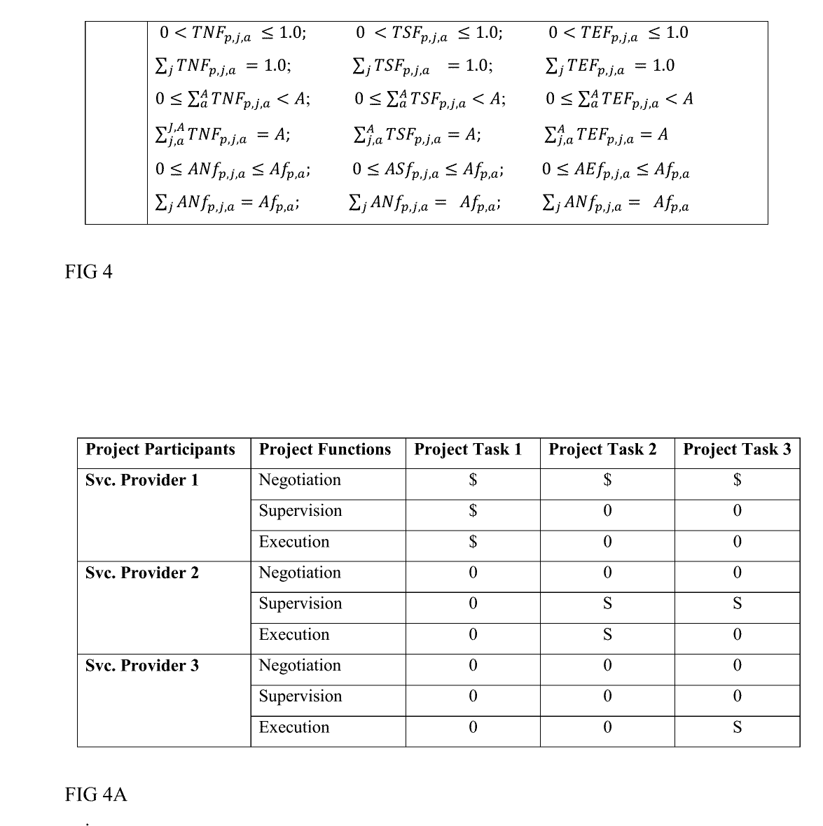

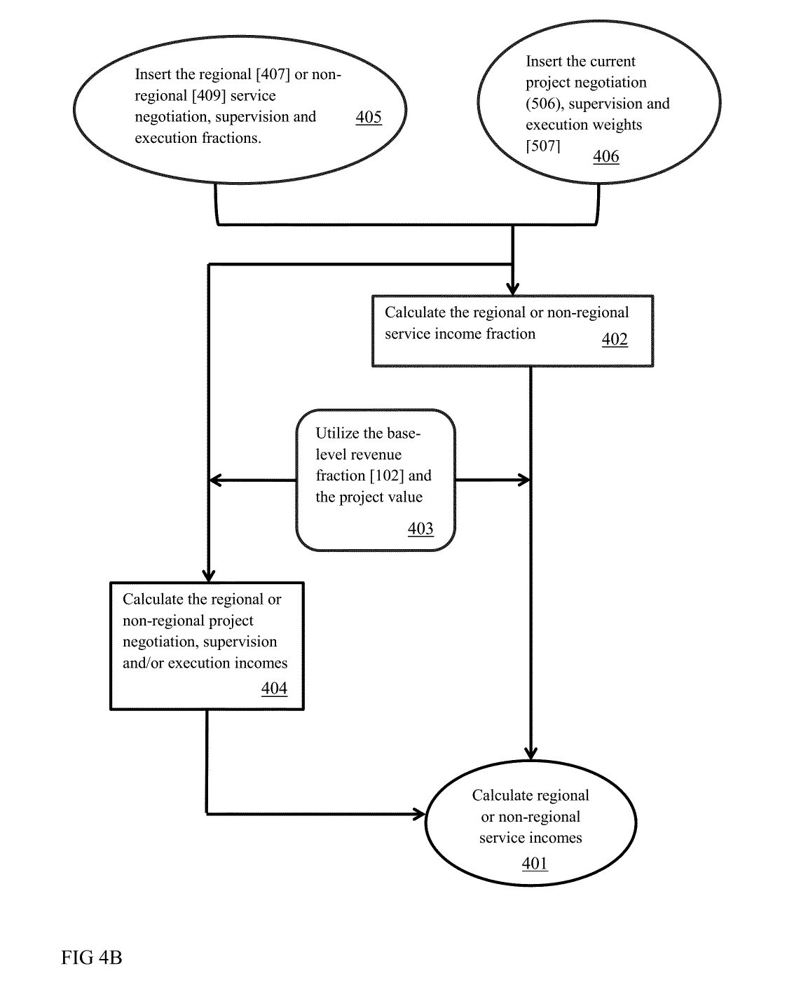

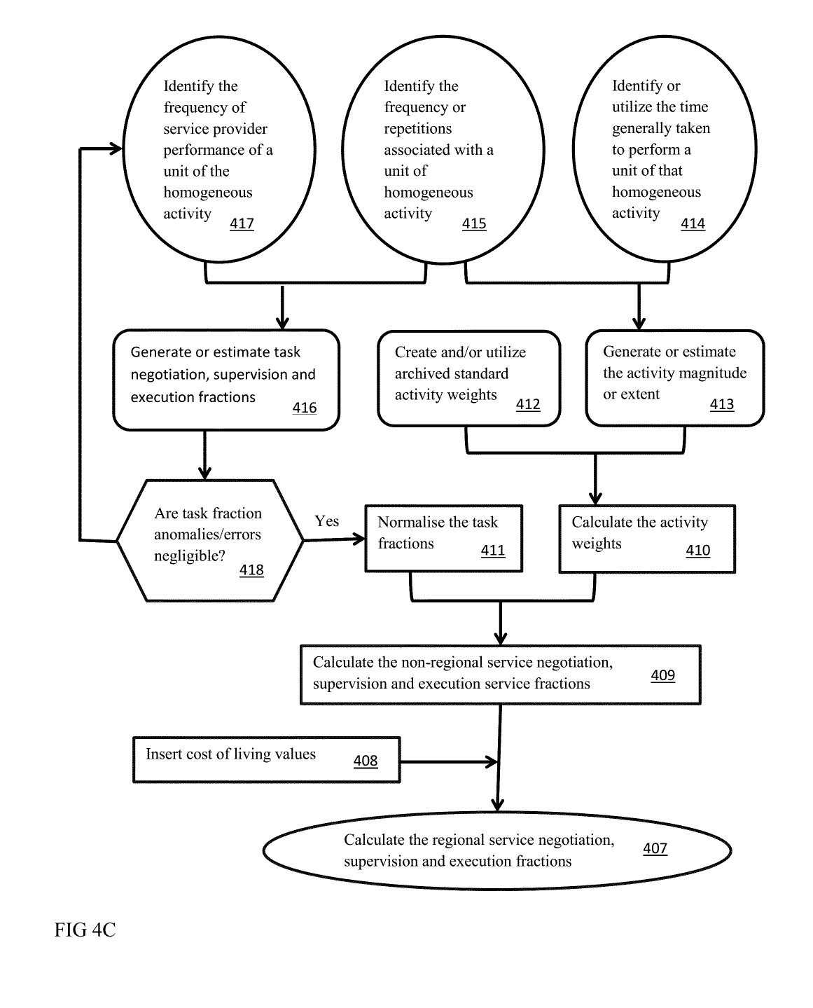

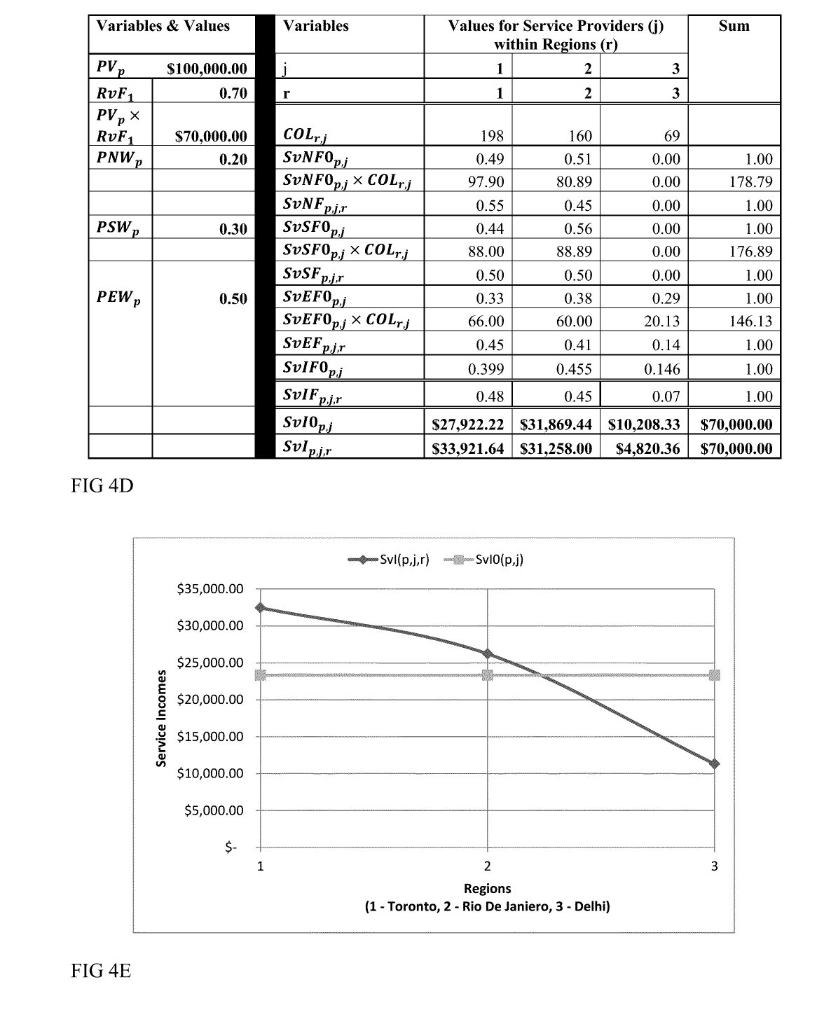

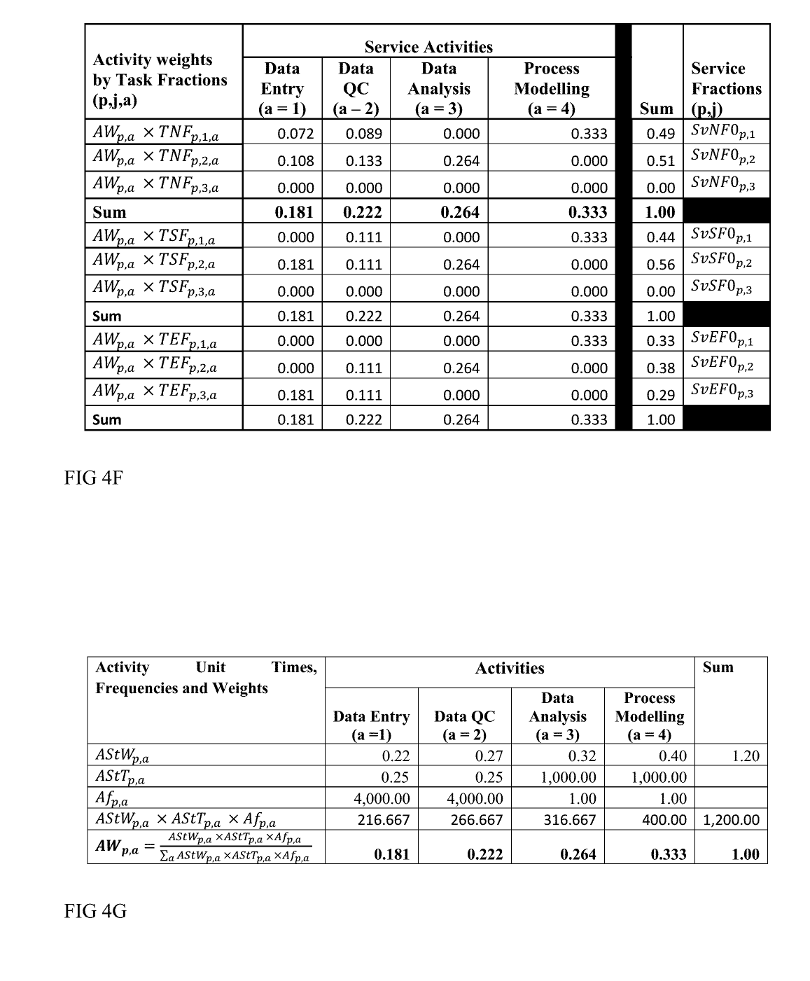

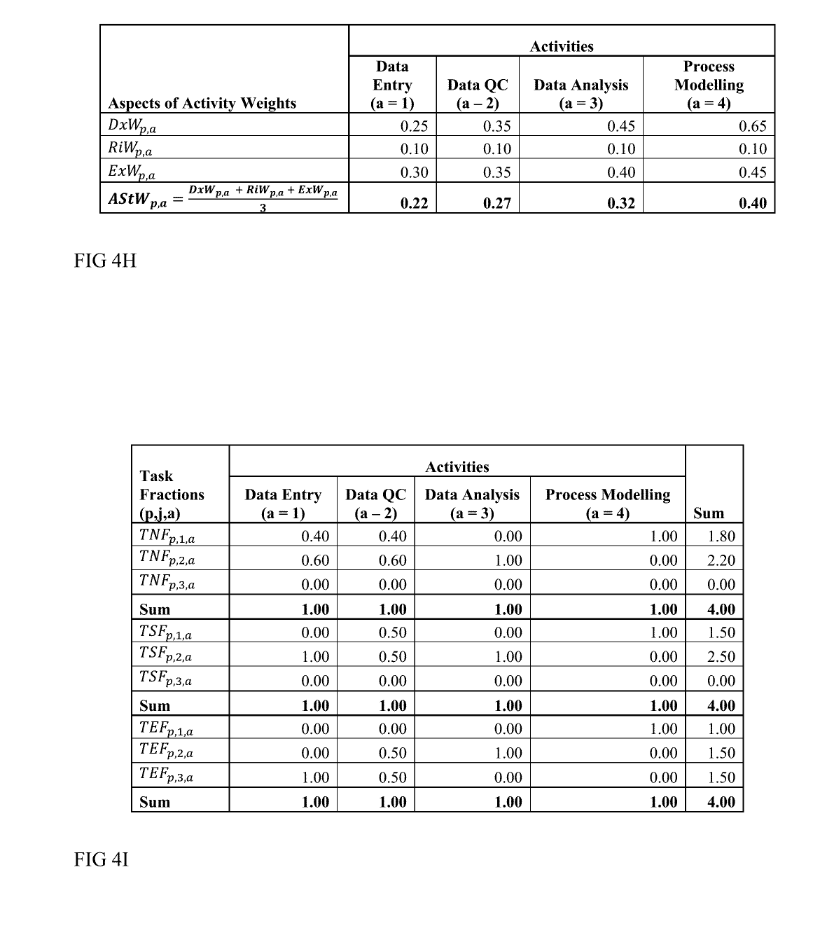

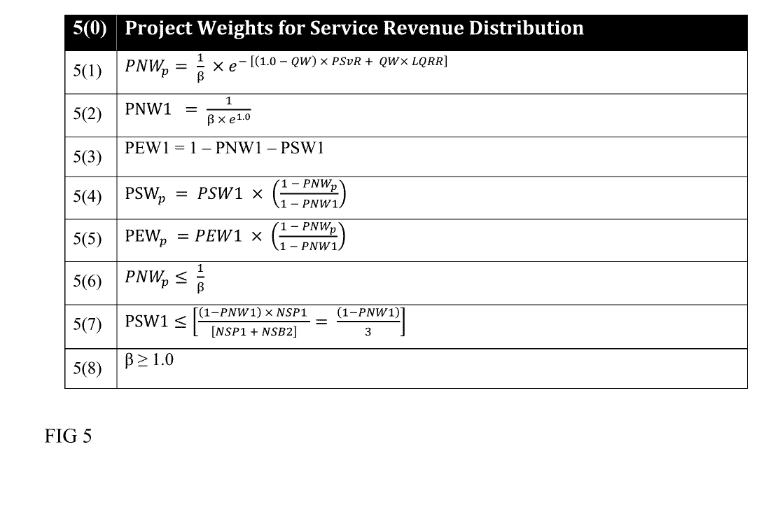

The targeted minimum earning, TMEₜ, is an agreed minimum collaboration fraction, MCFₜ (207, FIG. 2(8)), of the average of SvI_{t,p,j} (208, FIG. 4(1), 4(2)), which represents the incomes of currently listed service providers. The MCFₜ specification facilitates an objective of the hierarchical workspace invention to integrate new entrants into service provision with minimal impact on choice collaboration and service quality. In this integration strategy while all service providers are expected to utilize their knowledge, skills, and initiative to elevate their project participation and earnings, sub-TMEₜ service providers are identified to grant their participation in a MCFₜ of service provision with equivalent compensation. In preferred embodiments this MCFₜ disbursement is mandatory for each project, but in other embodiments it is discretionary.

The innovated project to service ratio, PSvRₜ (FIG. 2(9)), constituent of NRₜ(PSvR), serves as an indicator of project availability for service providers' continued occupation. Exploited for this assessment are the balanced relationships between project numbers, project values and service provider numbers, maintained by entry controls and attrition. Consequently, PSvRₜ, compares current ratios with historic or long term averages of corresponding ratios, in two components. Component 1 weighted LW, has for its current ratio, the number of pending and active projects, NPLCₜ (FIG. 2A, 209), relative to the number of service providers listed, NSCLₜ (209), and for its historic ratio, the number of projects done, NPHₜ (209), relative to the number of service providers listed at that time, NSLHₜ (209). Component 2 has for its current ratio, the pending and active project value, PVCₜ (209), relative to the number of service providers listed, NSCLₜ, and for its historic ratio, the project value done, PVHₜ (209), relative to the number of service provider listed at that time, NSLHₜ (209).

FIG. 2B is a plot showing that in the application, among the lower quartile of ranked earners, as the average of their earnings, ALQEₜ (FIG. 2A, 205 and FIG. 2(6)), increase, the number of potential recruits, NRₜ (201 and FIG. 2(1)), and the cap on the permissible number of chronologically queued novice recruits, NNRXₜ (FIG. 2(4)) also increase. The NRₜ values are influenced by the lower quartile remuneration ratio, LQRRₜ (202 and FIG. 2(5)), assessing income adequacy, which is weighted RW (=0.5), against the project to service ratio, PSvRₜ (203 and FIG. 2(9)), assessing project adequacy. The lower quartile remuneration ratio, LQRRₜ, is the ratio of the average of lower quartile earnings, ALQEₜ relative to the targeted minimum earning, TMEₜ (206 and FIG. 2(8)), the latter being the minimum collaboration fraction, MCF (207 and FIG. 2(8)), of the average of all current service incomes, SvI_{t,p,j} (208 and FIG. 4(1, 2)). Meanwhile, NNRXₜ (FIG. 2(4)), is the proportion of NRₜ (FIG. 2(1)), derived using the longer-term average of the number of novice, NNHₜ, relative to the total number of service provider, NSHₜ (204), participants, in historic projects.

FIG. 2C is a plot that demonstrates the increasing number of potential recruits, NRₜ(LQRR), FIG. 2(2), evaluated from the perspective of the lower quartile remuneration ratio, LQRRₜ (FIG. 2A, 202 and FIG. 2(5)). Weighted RW (=0.5), these NRₜ(LQRR) values partially contributed to the NR_{τ} (201 and FIG. 2(1)), values in FIG. 2B. The lower quartile remuneration ratio, LQRRₜ, indicates income adequacy as assessed from the average of lower quartile earnings, ALQEₜ relative to the targeted minimum earning, TMEₜ (206 and FIG. 2(8)), which is the minimum collaboration fraction, MCFₜ (=0.1 here; 207 and FIG. 2(8)), of the average of all service incomes, SvI_{t,p,j} (208 and FIG. 4(1, 2)). This MCFₜ (=0.10, here) is a project work disbursement to foster novice integration and development. With more than adequate lower quartile earnings, LQRRₜ>1.0, these NRₜ(LQRR) values are supportive of additional recruitment.

FIG. 2D is a plot that demonstrates the increasing number of potential recruits, NRₜ(PSvR) (FIG. 2A, 203 and FIG. 2(3)), evaluated from the perspective of the project to service ratio, PSvRₜ (203 and FIG. 2(9)). These NRₜ(PSvR) values partially contributed to the NRₜ (201 and FIG. 2(1)), values in FIG. 2B. The project to service ratio, PSvRₜ (FIG. 2(9)), serves as an indicator of project availability for service providers' continued occupation as assessed from its 2 components. Component 1, weighted LW (=0.5, here), has the number of pending and active projects, NPLCₜ (209), relative to the number of service providers, NSLCₜ (209), both currently listed, compared with the historic or longer-term average of the number of projects done, NPHₜ (209), relative to the number of service providers listed, NSLHₜ (209), Component 2 has, the comprehensive pending and active project value, PVCₜ (209), relative to the number of service providers, NSLCₜ, both currently listed, compared with the historic or longer-term average of the project value done, PVHₜ (209), relative to the number of service providers listed, NSLHₜ. With more than adequate project work available, PSvRₜ>1.0, these NRₜ(PSvR) values are also supportive of additional recruitment.

In the objective to support career development within the hierarchical workspace, competent service providers may be promoted to service coordinator positions, in which they will oversee multiple projects at any given point in time and receive level l=2 income. Systematic, but sustainable service provider promotion requires consistency between the number of coordinators, NCₜ (FIG. 2A, 210 and FIG. 2(10)), and the number of service providers listed, NSLCₜ. This consistency is maintained by use of a coordination number fraction, CNFₜ>0.333, (211 and FIG. 2(11)), set permanently, or for extensive periods of time, which together with the ratio, RF₂, to RF₁ (212 and FIG. 1(1)), of revenue fractions, and NSLCₜ, determines NCₜ. The lower CNFₜ≧0.333 limit was determined with similar consideration as for the lower RvF₁ (FIG. 1(2))≧0.667 limit. The coordination number fraction is set by management, usually below its upper bound (=1.0; FIG. 2(11)) to maintain the average of coordination earnings above the average of service provision earnings.

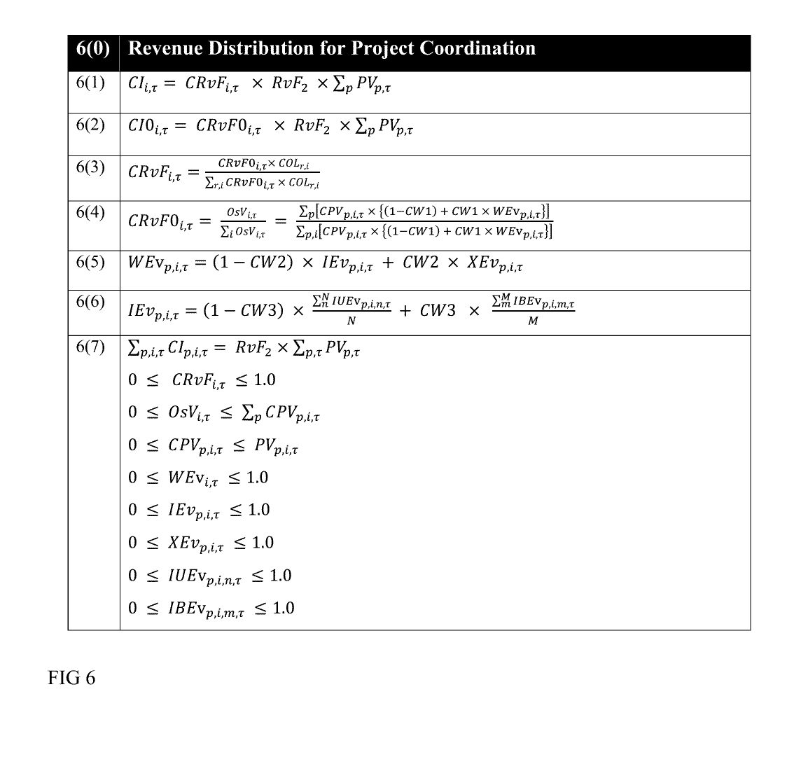

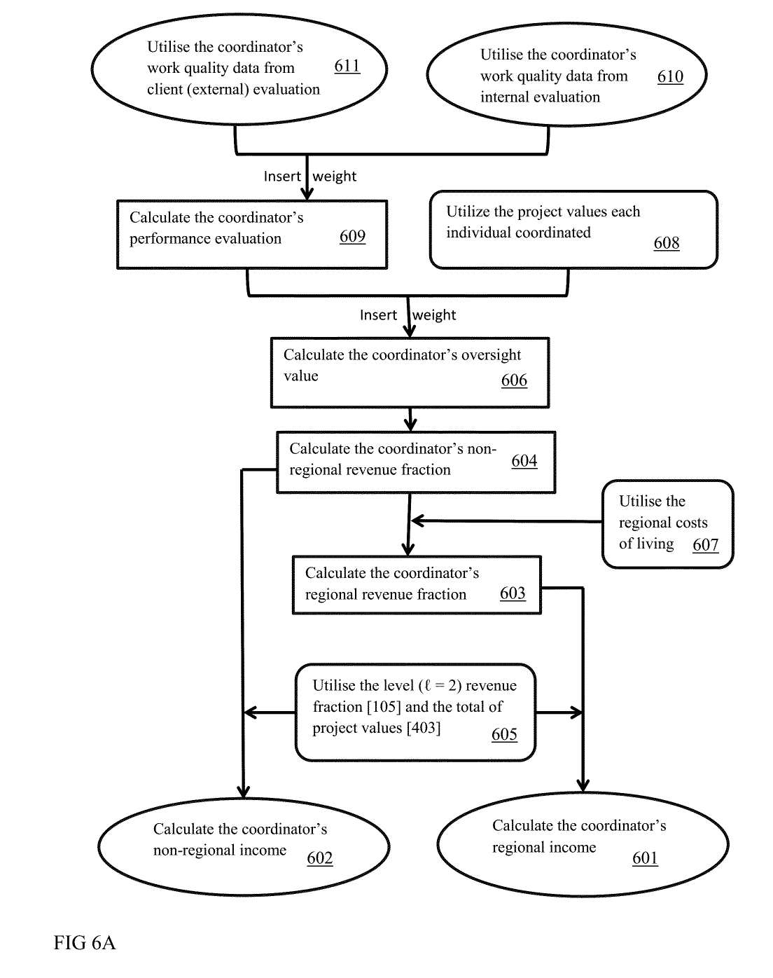

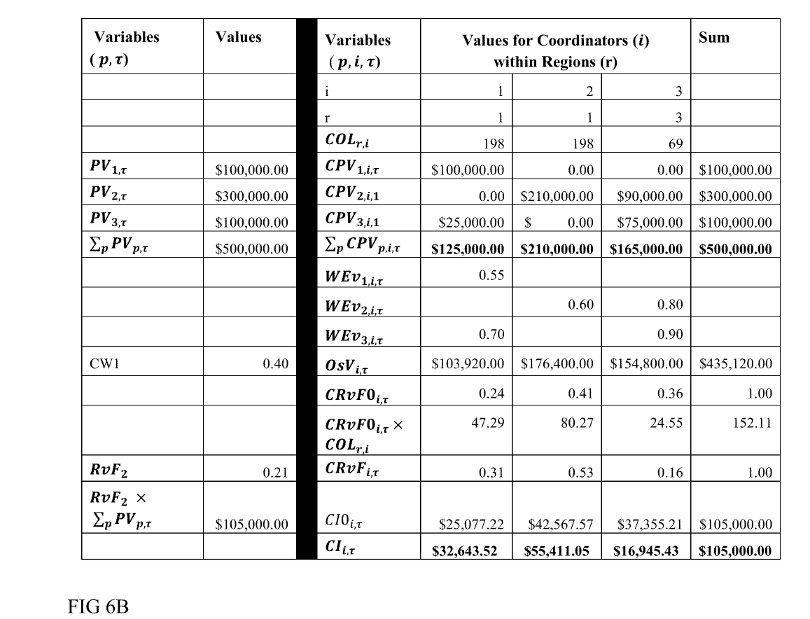

FIG. 2E is a table of the number of coordinators, NCₜ (FIG. 2A, 210 and FIG. 2(10)), allowed in association with the number of service providers listed, NSLCₜ, for a hierarchical workspace α=1.0, L=4, LF≈0.343 configuration, with a project value, PVₚ (=$100,000.00), as in FIG. 1D. As formulated, for given values of the revenue fractions RvF₂ and RvF₁ (212 and FIG. 1(1)), the coordination number fraction, CNFₜ≧0.333 (211 and FIG. 2(10)) limits the number of coordinators, NCₜ, to keep the average of their earnings, Avg(CI_{i,τ}), at least equivalent to the level l=1 average of service provider earnings, Avg (SvI_{t,p,j,r}). Nevertheless individual coordinator earnings, CI_{i,τ} (FIG. 6A, 601 and FIG. 6(1)), and individual service provider earnings, SvI_{t,p,j,r} (FIG. 4B, 401 and FIG. 4(1, 2)), are dependent on their personal productions. Reconciliation gives, RvF₁×PVₚ=$66,666.58, which balances NSLC_{τ}×Avg (SvI_{t,p,j,r}), and RvF₂×PVₚ=$22,833.90, which balances NCₜ×Avg(CI_{i,τ}).

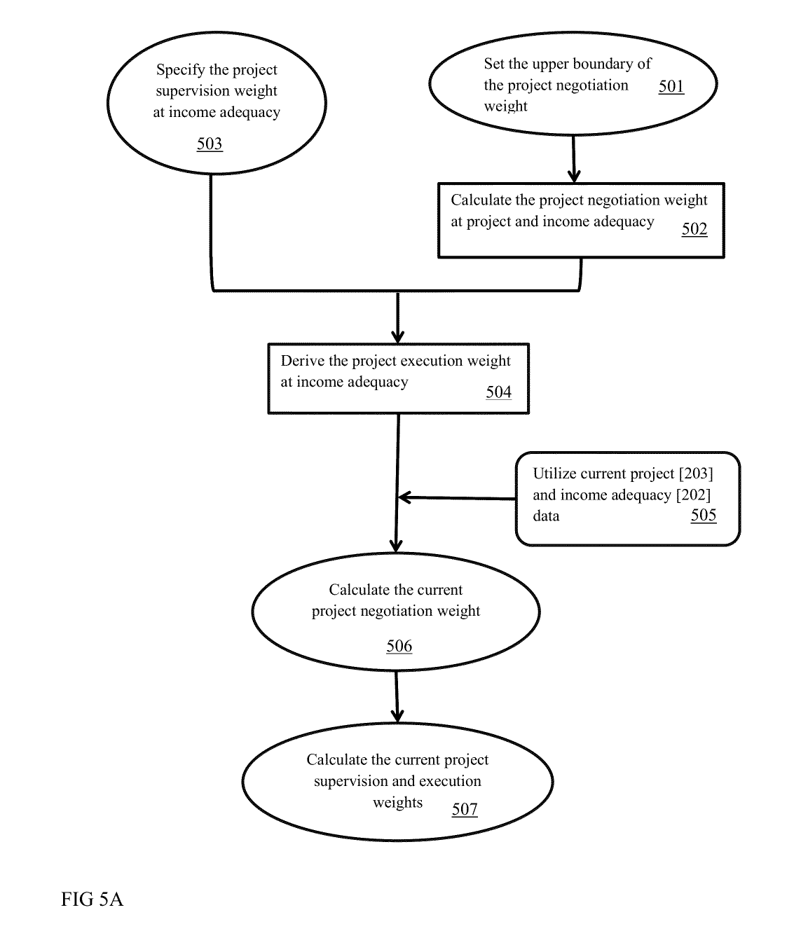

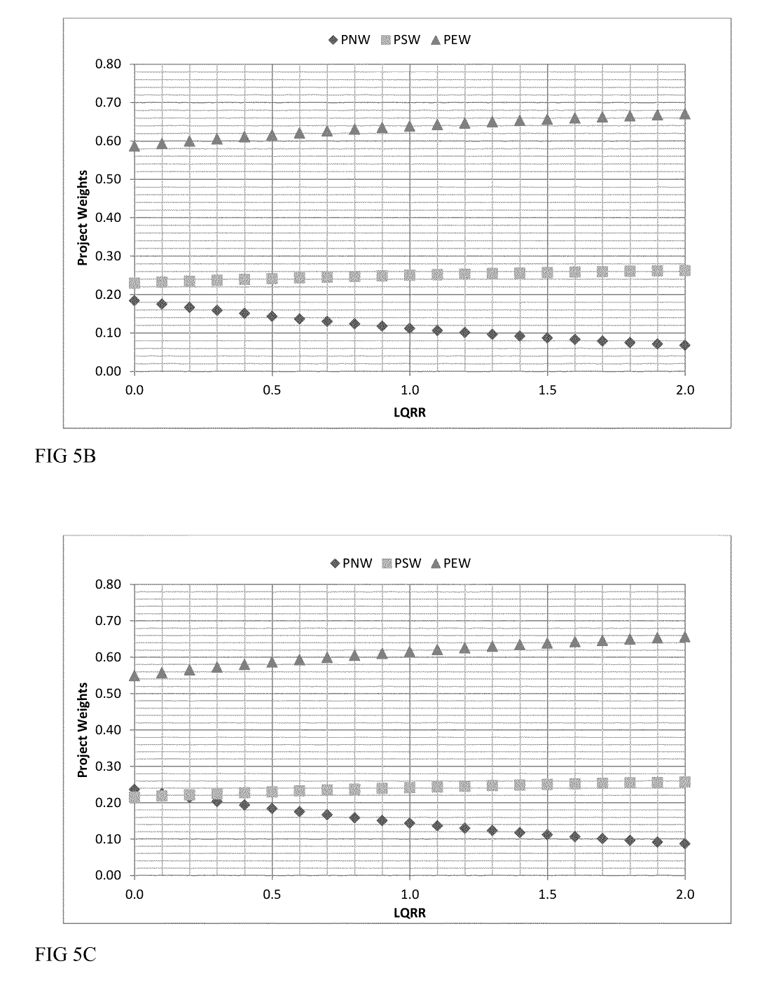

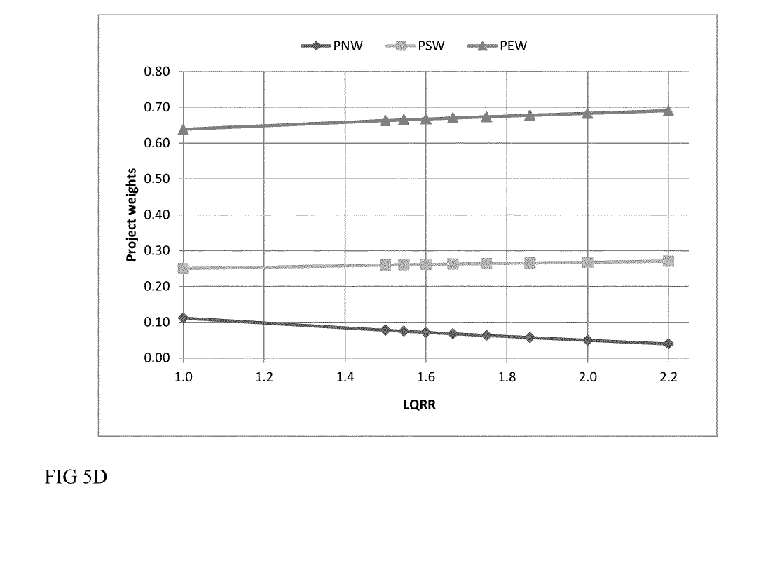

The coordination number fraction associates additional service provider listings with additional promotions. The service provider additions are influenced by income adequacy via LQRRₜ, and project availability via PSvRₜ, which these service providers can impact thorough their own efforts. In return, the service providers' successes in their endeavours to increase project sourcing and project incomes will increase their eligibility for promotion. In another aspect of this interconnectivity, while income and project inadequacy diminishes recruitment numbers, these inadequacies incentivise project sourcing through the LQRRₜ and PSvRₜ influenced enhancements of the project negotiation weight, PNWₚ (FIG. 5(1)), used in service provider income calculations.

### Service Provider Performance Evaluation

Service provider promotions are based on their performance evaluations, in terms of the extent of their project involvement, their quality of work and their support for novices. Consequently, for this aspect of the innovation, over an assessment period, T, involving projects indexed, p, the performances of service providers indexed, j, are evaluated by their service values, accumulated over a long enough period to blend time-in with superior performance. In preferred applications service values are evaluated as running totals or running means over 5 years, while in other embodiments shorter-term or longer-term evaluation periods can be assigned. Nevertheless, providing that level l=2 has the capacity to accommodate additional coordinators, service providers with relatively higher service values can be promoted to one of these level l=2 coordinator positions at any time during the assessment period.

FIG. 3A, follows the process of establishing service values, while FIG. 3B demonstrates its application via the algorithm component in FIG. 3. Each service value, SvV_{j,τ} (FIG. 3A, 301 and FIG. 3(1)), is a weighted average of the dollar values from the service provider's roles in project or service negotiation, supervision and execution as represented by variables, SvNV_{j,τ}, SvSV_{j,τ}, and, SvEV_{j,τ} (302 and FIGS. 3(2 to 4)), respectively, with the relative importance of these roles, in the assessment, being determined by service weights SW1 and SW2.

The service negotiation, supervision and execution values, SvNV_{j,τ}, SvSV_{j,τ}, SvEV_{j,τ}, have as inputs, the corresponding project role incomes, PNI0_{p,j,τ}, PSI0_{p,j,τ} PEI0_{p,j,τ} (303 and Section 2400; FIGS. 4(8 to 10)), of service providers. However, weighted by SW4, these PNI0_{p,j,τ}, PSI0_{p,j,τ}, PEI0_{p,j,τ} influences are moderated by the service provider's work quality evaluations, WEv_{p,j,τ} (304 and FIG. 3(7)), while weighted by SW3 the PSI0_{p,j,τ} influence is elevated by the service provider's adherence, MCA_{j,τ} (305 and FIG. 3(5)), to the minimum collaboration fraction MCF_{τ} (FIG. 2(8)), of work and earnings, specified as a disbursement to support novice integration and development.

The service provider's assessed adherence, MCA_{j,τ} (305 and FIG. 3(5)), to this minimum collaboration fraction, MCP_{τ} (306 and FIG. 2(8)), is validated by his/her collaboration participation score, MCP_{p,j,τ} (306 and FIG. 3(6)), which together with a generally applied collaboration constant, C (≧1, FIG. 3(9)), as a multiple, boosts the service provider's supervision value, SySV_{j,τ}, and consequently their service value, SvV_{j,τ}. In preferred embodiments MCP_{p,j,τ}=0, 1 for non-participation and participation, respectively, while in other embodiments, a larger value e.g. 2 can be assigned to reflect the greater risk in collaborating with service providers ranked closer to the bottom of the earning spectrum.

FIG. 3B is a table of simulated service values, SvV_{j,τ} (FIG. 3A, 301 and FIG. 3(1)), for service providers indexed, j (=1, 2, 3), involved in a project indexed, p (=1), valued PVₚ=$100,000.00, of which $70,000.00 is distributed among the service providers as in FIG. 4D and for the period indexed, τ=1. Each SvV_{j,τ} is a weighted average of its components for negotiation, SvNV_{j,τ}, supervision, SySV_{j,τ}, and execution SvEV_{j,τ} (302 and FIGS. 3(2 to 4)), which are calculated form corresponding project income components, PNI0_{p,j,τ}, PSI0_{p,j,τ}, PEI0_{p,j,τ} (303; Section 2400; FIGS. 4(8 to 10)), and work quality evaluations, WeV_{p,j,τ} (304 and FIG. 3(7)). The project incomes, PNI0_{p,j,τ}, PSI0_{p,j,τ}, PEI0_{p,j,τ}, result when the service negotiation, supervision and execution fractions, SvNF0_{p,j,τ}, SvSF0_{p,j,τ}, SvEF0_{p,j,τ} (FIGS. 4(16 to 18)), of the corresponding project weights, PNWₚ, PSWₚ PEWₚ (Section 2400; FIG. 4A, 406 and FIG. 5(1, 4, 5)), subdivide the revenue fraction, RvF₁ (FIG. 1B, 102 and FIG. 1(1)), of the project value PVₚ. Here, in this specific case SW3=0.20, weighs mandatory collaboration adherence, MCA_{j,τ} (FIG. 3A, 305 and FIG. 3(5)), while SW4=0.40 places a little more emphasis on work quality evaluation, WEv_{p,j,τ} (304 and FIG. 3(7)), and SW2=0.50 gives priority to service supervision, SvSV_{j,τ}, over its negotiation, SvNV_{j,τ}, and execution SvEV_{j,τ} counterparts. Cost of living, COL_{r,j}, differences are never considered in these service value calculations. In these results, consequential to superior work quality, despite less earnings, SvI0_{p,j,τ}, than service provider 2, service provider 1 with the largest service value, SvV_{j,τ}, is favoured for promotion.

The work quality evaluation, WEv_{p,j,τ}, has an external or client evaluation component, XEv_{p,j,τ} (FIG. 3A, 307), weighted by SW5 against an internal evaluation component, IEv_{p,j,τ}. The internal evaluation component, IEv_{p,j,τ} (308 and FIG. 3(8)), has a subordinate evaluation sub-component, IBEv_{p,j,m,τ}, weighted by variable, SW6, against a supervisor evaluation sub-component, IUEv_{p,j,n,τ}, where subscript, m, counts evaluating subordinates, while subscript, n, counts evaluating supervisors.

Revenue Distribution, for Service Provision, with the Hierarchical Workspace System

A significant aspect of the process innovated to optimise the occupation and collaboration objectives of the hierarchical workspace, involves ease and consistency in the allocation of fixed price project revenue to compensate the semi-independent service provision associated with the service providers' choice engagements. Service providers are contracted by service requesters at an agreed price. The service providers self-organise to service the request, subject to the engagement and oversight rules and revenue distribution format of the hierarchical workspace. Service providers participating in any given project are compensated portions of the fixed-price project earning, based on the relative values of their tasks.

The service provided by individuals is valued from an innovated algorithm module, (FIG. 4), devised for a proportionate pay structure with base level revenue fraction, RvF₁ (FIG. 1B, 102), constraints and involving service tasks associated with project negotiation, supervision and/or execution roles. A cost of living variable is incorporated into the formulae, to maintain parity in compensating service providers operating across global economic regions, by considering the relative country or regional value in utilizing the incomes shared in service provision.

FIG. 4A displays a simplified project negotiation, supervision, and execution interaction applicable at the RvF₁ level of the hierarchy in FIG. 1A, and is demonstrated with 3 participating service providers. Service Provider 1 is compensated as symbolised by, $, as the sole project negotiator, and for executing task 1, with self-supervision. Service provider 2 is compensated for executing task 2 with self-supervision and for supervising Service Provider 3 who executed task 3. Here, the value, 0, symbolises no compensation as a result of non-participation in that specific role and activity.

FIG. 4B and FIG. 4C represent the process for determining service incomes for collaborating service providers at the base, RvF₁, level of the hierarchical workspace, while FIGS. 4D to 4I demonstrate its application.

The regionalised service income with cost of living incorporated and the non-regionalised service income, SvI_{p,j,r} (FIG. 4B, 401; FIG. 4(1, 2)), and, SvI0_{p,j} (401; FIG. 4(3, 4)), respectively, are each the corresponding service income fraction, SvIF_{p,j,r}, SvIF0_{p,j} (402; FIG. 4(11, 12)), of the level revenue fraction, RvF₁ (102), subdividing the project value, PVₚ (403), after expenses. Here, SvI_{p,j,r}, SvI0_{p,j,r}, may each also be expressed in terms of aggregated regional, non-regional project income components for negotiation, PNI_{p,j,r}, PNI0_{p,j} (404, FIG. 4(5, 8)), supervision, PSI_{p,j,r}, PSI0_{p,j} (FIG. 4(6, 9), and execution, PEI_{p,j,r}, PEI0_{p,j} FIG. 4(7, 10).

As constituents of SvI_{p,j,r} (FIG. 4(1, 2)), SvI0_{p,j} (FIG. 4(3, 4)), each SvIF_{p,j,r}, SvIF0_{p,j} (FIG. 4(11, 12)), has components for service negotiation, SvNF_{p,j,r}, SvNF0_{p,j} (405), supervision, SvSF_{p,j,r}, SvSF0_{p,k}, and execution, SvEF_{p,j,r}, SvEF0_{p,j}, representing the service provider's proportion of corresponding weights allocated for their project negotiation, PNWₚ, supervision, PSWₚ, and/or execution, PEWₚ, (406, FIG. 5(1, 4, 5)) roles. Consequential to cost of living considerations, in preferred application only the regionalised service incomes, SvI_{p,j,r}, are allocated to service providers, in association with their individually generated service income fraction, SvIF_{p,j,r}, which is also applicable to homogenous economic region(s), where, as formulated, it generates values that are equivalent to those of SvIF0_{p,j}.

In effect the non-regional role-related service fractions, SvNF0_{p,j}, SvSF0_{p,j}, SvEF0_{p,j} (FIG. 4(16, 17, 18), represent the portions of work actually done in the negotiation, supervision and execution categories, hence each regional role-related service fraction, SvNF_{p,j,r}, SvSF_{p,j,r}, SvEF_{p,j,r} (407, FIG. 4(13, 14, 15)), is devised using its non-regional counterpart with regional cost of living, COL_{r,j} (408), modifications included, to elevate the incomes of participating service providers resident in higher cost regions, as a regional spending equity provision, for equivalent work done.

FIG. 4D is a table of simulated level l (=1), non-regionalised and regionalised service incomes, SvI0_{p,j} (FIG. 4B, 401 and FIG. 4(3, 4)) and SvI_{p,j,r} (401; FIG. 4(1, 2)), respectively, for service providers indexed, j (=1, 2, 3), involved in a project indexed, p (=1), valued at PV₁=$100,000.00, with $70,000.00 shared among the service providers, while the remaining $30,000.00 is allocated to the higher RvEₗ levels l=2, 3, 4. As discussed, the service incomes, SvI0_{p,j}, SvI_{p,j,r}, are the corresponding service income fractions, SvIF0_{p,j}, SvIF_{p,j,r}, of the revenue fraction, RvF₁, subdividing the project value, PV₁. Each, SvIF0_{p,j}, SvIF_{p,j,r} has components for negotiation, SvNF0_{p,j,r}, SvNF_{p,j} (405), supervision, SvSF0_{p,j,r}, SvSF_{p,j}, and execution, SvEF0_{p,j,r}, SvEF_{p,j}, which subdivide corresponding project weights PNWₚ (406; FIG. 5(1)), PSWₚ, and, PEWₚ. In effect the non-regional role-related service fractions represent the portions of work actually done. Hence each regional role-related service fraction is devised using its non-regional counterpart with a regional cost of living, COL_{r,j} (FIG. 4C; 408), modification, applied to elevate the incomes of service providers resident in higher cost regions. Utilised here is the Expatistan Cost of Living Index, coded from the November, 2014 values as COL_{r,j}=198, 160, 69 for the regions Toronto (r=1), Rio De Janiero (r=2) and Delhi (r=3), respectively.

FIG. 4E is a plot which compares the service incomes, SvI0_{p,j} (FIG. 4B, 401; FIG. 4(3, 4)) non-regional, and SvI_{p,j,r} (401; FIG. 4(1, 2)) regional, each totaling $70,000, distributed among 3 collaborating service providers with equivalent service income fractions, SvIF0_{p,j} (402; FIG. 4(12)), but resident in the 3 economic regions, r, listed. Here SvI_{p,j,r} incorporates the Expatistan Cost of Living Index, coded from the November, 2014 values as COL_{r,j}=198, 160, 69 for the regions Toronto (r=1), Rio De Janiero (r=2) and Delhi (r=3), respectively, while SvI0_{p,j} does not. Consequently, SvI_{p,j,r} values are higher for service providers operating from higher COL_{r,j} regions. Using these numbers, for additional rudimentary analysis, the equivalent total service income after expenses for a similar project based in India would be $24,393.94; with each participant earning $8,131.31, which is 28% less than the $11,311.48 awarded to the Indian participant in the Toronto project, as assumed. Consequently, as an added benefit, the cost of living variable contributes regional variations in incomes that support the lowering of project pricings with the outsourcing of aspects of project activities to colleagues resident in lower cost regions. Otherwise such outsourcing enhances the incomes of individuals in higher and lower cost regions.

The non-regionalised role-related service fractions, SvNF0_{p,j}, SvSF0_{p,j}, SvEF0_{p,j}, (FIG. 4C, 409 and FIGS. 4(16 to 18)) consist of homogenous activity or sub-activity weights, AW_{p,a} (410, FIG. 4(19)), indexed, a, that are subdivided by the service provider's role-related task fractions, TNF_{p,j,a}, TSF_{p,j,a}, TEF_{p,j,a} (411, FIGS. 4(24 to 26)), which represent their contributions to service negotiation, supervision and execution, respectively. In its application, any given service provider with TSF_{p,j,a}=TEF_{p,j,a} is self-supervised, otherwise with 0<TSF_{p,j,a}<TEF_{p,j,a} the individual is partially supervised and with TSF_{p,j,a}=0, the service provider is fully supervised, while with TSF_{p,j,a}>TEF_{p,j,a}, the service provider is supervising himself and a colleague.

FIG. 4F is a table displaying the non-regional service fractions generated for service negotiation, SvNF0_{p,j}, supervision, SvSF0_{p,j}, and execution, SvEF0_{p,j}, (405, 409; FIGS. 4(16 to 18)) and utilised in FIG. 4D for service providers, j (=1, 2, 3), involved in aspects of the project activities, a (=1, 2, 3, 4). These service fractions derive from the corresponding task fractions, TNF_{p,j,a}, TSF_{p,j,a}, TEF_{p,j,a} (411; FIGS. 4(24 to 26)), in FIG. 4I and from the activity weights, AW_{p,a} (410, FIG. 4(19)), in FIG. 4G.

The weight, AW_{p,a} (FIG. 4(19)), of a unit of homogeneous activity is its innovated standard activity weight, AStW_{p,a} (412; FIG. 4(20)), extended by its magnitude, AM_{p,a} (413; FIG. 4(19)), the latter being its standard completion time, AStT_{p,a} (414; FIG. 4(19)), repeated by the use of a frequency number Af_{p,a} (FIG. 4(21)).

FIG. 4G is a table of standard weights, AStW_{p,a} (411; FIG. 4(20)), standard times, AStT_{p,a} (414) and the frequency numbers, Af_{p,a} (415), for units of homogeneous activities, utilized to generate the activity weights, AW_{p,a} (410; FIG. 4(19)), in FIG. 4F for the project indexed, p (=1), with homogeneous activities, a (=1, 2, 3, 4).

Standard activity weights are modal values forming a quasi-permanent spectrum, from independent professional value rankings of homogeneous project or service activities. In their determination, standard activity weights, AStW_{p,a} (FIG. 4(20)), are evaluated in the dexterity, DxW_{p,a} risk, RiW_{p,a} and exertion, ExW_{p,a} categories, currently numbering, NAW=3, although other activity weight categories can be added in the future. The dexterity weight, DxW_{p,a} (FIG. 4(22)), is an average of its physical and mental components, DxPW_{p,a} and, DxMW_{p,a}, respectively. Similarly the exertion weight, ExW_{p,a} (FIG. 4(23)), is an average of its physical and mental components, ExPW_{p,a} and, ExMW_{p,a}.

FIG. 4H is a table of the values used to generate the standard activity weights AStW_{p,a} (411, FIG. 4(20)), in FIG. 4G, for the project, p (=1), with activities a (=1, 2, 3, 4), utilising components of weights for dexterity, DxW_{p,a} (FIG. 4(22))), risk, RiW_{p,a}, and exertion, ExW_{p,a} (FIG. 4(23)).

Standard activity times, AStT_{p,a}, are modal values from professional time estimates for the completion of a unit of a given homogeneous activity, while activity frequencies, Af_{p,a} (415; FIG. 4(21)), are the time repetitions that generate the total activity time. Service negotiation, supervision and execution, are aspects of the same activity, consequently for each of these roles the activity time accumulates to the same total.

Another objective of this innovation for service income allocation is to facilitate the pre-project estimate and post-project determination of service provider contributions, to fixed-price projects tasks, with options for service provider self-valuation of their contribution. Consequently, the task fractions, TNF_{p,j,a}, TSF_{p,j,a} and TEF_{p,j,a} (FIGS. 4(24) to 4(26)), for project negotiation, supervision and execution activities respectively, are normalised proportions of corresponding preliminary informed estimates, TNF0_{p,j,a}, TSF0_{p,j,a} and TEF0_{p,j,a} (416; FIGS. 4(27 to 29)), provided by service providers.

FIG. 4I is a table of the task fractions for service negotiation, TNF_{p,j,a}, supervision, TSF_{p,j,a}, and execution, TEF_{p,j,a} (411; FIGS. 4(24 to 26)), assigned to service providers, j (=1, 2, 3), involved in aspects of project activities a (=1, 2, 3, 4). These task fractions were utilized in the generation of the corresponding service fractions in FIG. 4F.

The preliminary role-related task fractions, TNF0_{p,j,a}, TSF0_{p,j,a} and TEF0_{p,j,a} (FIGS. 4(27 to 29)), consist of corresponding individual service provider role-related activity repetitions or frequency numbers, ANf_{p,j,a}, ASf_{p,j,a}, AEf_{p,j,a} (417), which are compared with the comprehensive activity frequency number, Af_{p,a} (415; FIG. 4(21)), to generate the task fractions. For more simplistic estimates, or otherwise for activities lacking identifiable repetitive tasks, the comprehensive activity frequency Af_{p,a}, is assigned the value 1.0 and the role-related activity frequency numbers, ANf_{p,j,a}, ASf_{p,j,a}, AEf_{p,j,a}, are assigned as role-related activity fractions.

Significant anomalies or errors, eTNF0_{p,j,a}, eTSF0_{p,j,a}, eTEF0_{p,j,a} (418; FIGS. 4(30 to 32)), in self-determined role-related task fractions, TNF0_{p,j,a}, TSF0_{p,j,a}, TEF0_{p,j,a}, indicate service provider disagreements with respect to their task accomplishments, and these are flagged for their review and reassignment, while persisting disputes are adjudicated by coordinators.

In effect with the hierarchical workspace system, after the project value is negotiated, software generates values for revenue distribution and earnings, using: (a) the negotiated project value after expenses (b) the revenue fractions assigned to various levels (c) the current regional cost of living values (d) the static weights and parameters assigned by management (e) the standard activity weights provided by service providers (f) the standard activity times provided by service providers and (g) the agreed task fractions provided by service providers. Consequently, with this hierarchical workspace system, archived standard activity weights and standard activity times serve to simplify and standardise the revenue distributed in collaborative work. Service providers simply supply the negotiated project value and their task fractions for their negotiation, supervision and execution activities, from which the software generates their earnings, and their contributions to the hierarchical workspace sustenance and management.

### Project Weights for Revenue Distribution in Service Provision

As described earlier, in an aspect of the hierarchical workspace process invented to evaluate service provider compensation for fixed price project work, weights for project negotiation, PNWₚ (FIG. 5(1)), supervision, PSWₚ (FIG. 5(4)), and execution, PEWₚ (FIG. 5(5)), are service fractioned by corresponding role-related variables, SvNF_{p,j}, SvSF_{p,j}, SvEF_{p,j}, (FIG. 4C, 407; FIGS. 4(13 to 15)), representing the extent of the service provider's participation in the given project role.

The project negotiation weight has been designed to vary with project availability and income, while the project supervision and execution weights undergo compensatory changes to conserve revenue. In this weight variation, project sourcing is encouraged and rewarded through the elevation of project negotiation income in periods of project scarcity. Consequently, weighted by variable, QW, between assessments of income adequacy via LQRRₜ (FIG. 2A, 202; FIG. 2(5)), and project adequacy via PSvRₜ (203, FIG. 2(9)), the innovated project negotiation weight, PNWₚ (FIG. 5(1)), can increase exponentially to a value limited by, β (≧1.0). The project supervision weight, PSWₚ (FIG. 5(4)), is initially prescribed, while the project execution weight, PEWₚ (FIG. 5(5)), is initially determined as a residual.

FIG. 5A provides the process innovated for generating project weights that vary with project availability and earnings and that contribute to determining the income of collaborating service providers operating in the hierarchical workspace, while FIG. 5B to FIG. 5D demonstrate its application.

Specifically, commencing with QW=1.0 and LQRRₜ=0, or with QW=0 and PSvRₜ=0, the upper boundary for the project negotiating weight (FIG. 5A, 501; FIG. 5(1)), PNWₚ≦1/β is set by assigning a value to the parameter β. This project negotiation weight, PNWₚ (=PNW1 (502, FIG. 5(2))), is then valued at the income and project adequacy thresholds, which occur at LQRRₜ=1.0 and PSvRₜ=1.0. At this income and project adequacy threshold, the project negotiation weight, PNW1 (502; FIG. 5(2)), and a management specified project supervision weight, PSW1 (503; FIG. 5(3)), serve to determine the initiating project execution weight, PEW1 (504, FIG. 5(3)), as a residual.

To minimise excesses in setting the project supervision weight, this

$$PSW 1 ( \leq \frac{1 - PNW 1}{3} ; FIG 5 ( 7 ) ) ,$$

derives its upper boundary from the premise that each project supervisor, NSP1 is allowed a minimum of two subordinates, NSB2, with non-PNW1 income divided equally among these three persons, as a fairness prescription. In a case with, β=3.3, there are, PNWₚ≦0.3, and PNW1=0.11, giving PSW1≦0.297, approximately.

Once the initiating weights for project negotiation, PNW1, supervision, PSW1, and execution, PNW1, are determined, the project negotiation weight, PNWₚ (506, FIG. 5(1)), is allowed to vary in response to project and income availability (505), then to conserve revenue the weights for project supervision, PSWₚ (507; FIG. 5(4)), and execution, PEWₚ (507; FIG. 5(5)), also vary proportionately.

FIG. 5B is a plot of the variation of project weights for negotiation, PNWₚ (506; FIG. 5(1)), supervision, PSWₚ (507; FIG. 5(4)), and execution, PEWₚ (507; FIG. 5(5)), with the lower quartile remuneration ratio, LQRR (202; FIG. 2(5)). Assigned were β (FIG. 5(1))=3.3, restricting PNWₚ to a maximum value of 0.30, also assigned were PSW1 (503; FIG. 5(3))=0.25 and the project to service ratio, PSvR (203; FIG. 2(9))=1.0, the latter indicating project adequacy. Here, at income adequacy there is LQRR=1.0 at which PNWₚ=PNW1 (502; FIG. 5(2))=0.11, PSWₚ=PSW1 (503; FIG. 5(3))=0.25, and PEWₚ=PEW1 (504; FIG. 5(3))=0.64.

FIG. 5C is a plot of the variation of project weights for negotiation, PNWₚ (506; FIG. 5(1)), supervision, PSWₚ (507; FIG. 5(4)), and execution, PEWₚ (507; FIG. 5(5)), with the lower quartile remuneration ratio, LQRR (202; FIG. 2(5)). Assigned were β (FIG. 5(1))=3.3, restricting PNWₚ to a maximum value of 0.30, also PSW1 (503; FIG. 5(3))=0.25 (as above), but the project to service ratio, PSvR (203; FIG. 2(9))=0.5, was reduced to indicate project inadequacy. At income adequacy there is LQRR=1.0 at which these values when compared with those in FIG. 5B, give, PNWₚ=0.14 (+21%), PSWₚ (507; FIG. 5(4))=0.24 (−4%) and PEWₚ (507; FIG. 5(5))=0.62 (−3%). With the 50% project inadequacy prescribed here, project negotiation carried a greater weight to incentivise project sourcing.

FIG. 5D is a plot of the project weight responses to the unfulfilled recruitment needs in FIG. 2B; circumstances which enhance incentives for project execution via increases in the project execution weight, PEWₚ (507; FIG. 5(5)), rather than enhance incentives for project sourcing.

### Revenue Distribution for Project Coordination

When the number of service providers listed, NSLCₜ, is adequate, the more competent ones are promoted to add to the number, NCₜ, (FIG. 2A, 210; FIG. 2(10)), of coordinator, positions, in which they have duties that include providing advice on issues, adjudicating disputes, setting task timelines and when necessary redistributing tasks to ensure timely project completion. These coordinators share the level, f (=2), revenue fraction, RvF₂ (FIG. 1(1)), of the total value of projects done, but their individual incomes are assessed form personal oversight production. Since these coordinators have responsibility for outcomes, their incomes are also impacted by work quality evaluations.

FIG. 6A provides a summary of the process innovated for determining the coordinators' incomes, while FIG. 6B displays some simulated results. Over an assessment or revenue generation period, τ>t, any given coordinator indexed, i, has income CI_{i,τ}, (601; FIG. 6(1)), regionalized via cost of living inserts. Nevertheless, for comparison, the coordinator's income may be evaluated as a non-regionalized value, CI0_{i,τ} (602; FIG. 6(2)). These coordinator incomes, CI_{i,τ}, CI0_{i,τ} are each their corresponding coordination fraction, CRvF_{i,τ} (603; FIG. 6(3)) CRvF0_{i,τ} (604; FIG. 6(4)), of the level-2 revenue fraction, RvF₂ (605; FIG. 1(1)), subdividing each project value, PV_{p,τ} (403).

Both CRvF_{i,τ} (FIG. 6(3)) and CRvf0_{i,τ} (FIG. 6(4)), are essentially the coordinator's project oversight value, OsV_{i,τ} (606; FIG. 6(4)), relative to that of all of his or her colleagues, but only CRvF_{i,τ}, is actually utilised, as it incorporates regional cost of living, COL_{r,j} (607), influences, to preserve spending equity, in distributing incomes, CI_{i,τ}, to dispersed participants. This oversight value, OsV_{i,τ}, is the sum over the period, τ, of the coordinator's project value, CPV_{p,i,τ} (608), overseen, but moderated by the coordinator's work performance evaluation, WEv_{p,i,τ} (609; FIG. 6(5)), as weighted by CW1.

FIG. 6B is a table of simulated regionalised and non-regionalised coordinators' incomes, CI_{i,τ} (601; FIG. 6(1)), and, CI0_{i,τ} (602; FIG. 6(2)), respectively, for coordinators, i (=1, 2, 3), resident in economic regions r (=1, 1, 3), each overseeing aspects of projects p (=1, 2, 3), valued at PV_{p,τ}=$100,000.00, $300,000.00, $100,000.00, all done over some given period indexed, τ (=1), As discussed, these coordinator incomes, CI_{i,τ}, CI0_{i,τ} are each their corresponding individual coordination fraction, CRvF_{i,τ} (603; FIG. 6(3)) CRvF0_{i,τ} (604; FIG. 6(4)), of the revenue fraction, RvF₂ (605; FIG. 1(1)), subdividing PV_{p,τ} (403). Each CRvF_{i,τ}, CRvF0_{i,τ} (FIG. 6(3, 4)), is the coordinator's project coordination value, CPV_{p,i,τ} (608), but moderated (CW1=0.40) by his/her work performance evaluation, WEv_{p,i,τ} (609; FIG. 6(5)) and assessed relative to that of his/her colleagues. The regionalised income, CI_{i,τ}, is actually used as it involves regional cost of living, COL_{r,j} (607), values incorporated into CRvF_{i,τ} to preserve local spending equity, in compensating dispersed participants. Utilized here is the Expatistan Cost of Living Index, coded from the November, 2014 values as COL_{r,j}=198, 69 for Toronto (r=1) and Delhi (r=3).

The work quality or performance evaluation, WEv_{p,i,τ} (FIG. 6(5)), has an internal evaluation component, IEv_{p,i,τ} (610, FIG. 6(6)), and an external or client evaluation component, XEv_{p,i,τ} (611), weighted by CW2. This internal evaluation component, IEv_{p,i,τ} (FIG. 6(6)), has a supervisor evaluation sub-component, IUEv_{p,i,n,τ}, and a subordinate evaluation sub-component, IBEv_{p,i,m,τ}, weighted by, CW3. Here, subscript, n, counts evaluating supervisors while subscript, m, counts evaluating subordinates.

In preferred embodiments, group managers are identified and ranked top down by their larger group share fraction, as determined from the total of their founder's share fraction and their service coordinator's shares fraction described in the section “Share Fractioning”, below. In other less favoured embodiments, group managers may be appointed from among founders and service coordinators.

### Share Fractioning

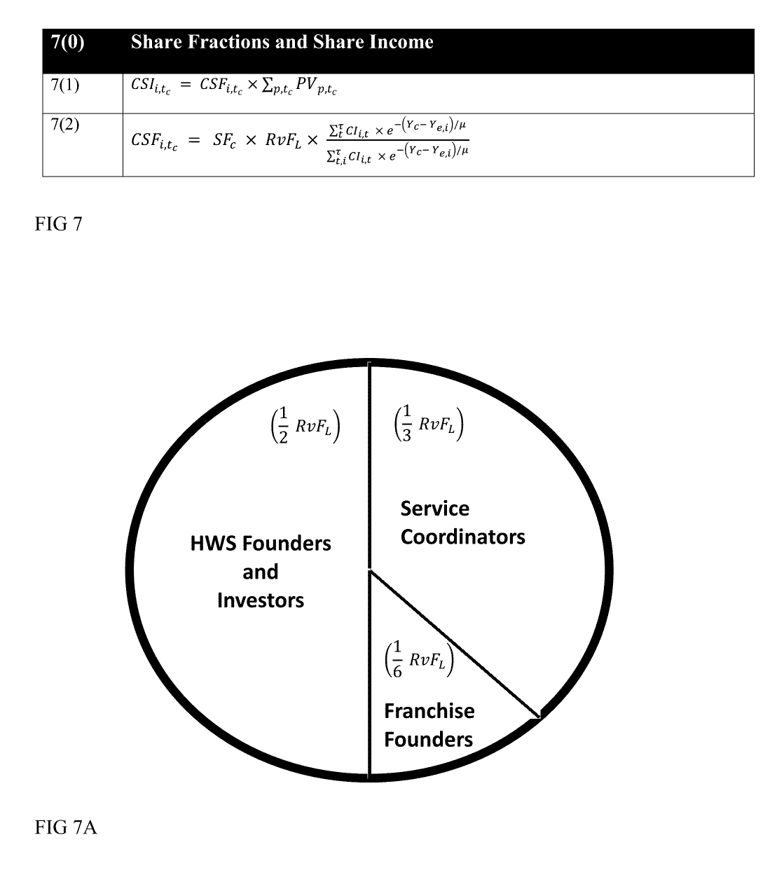

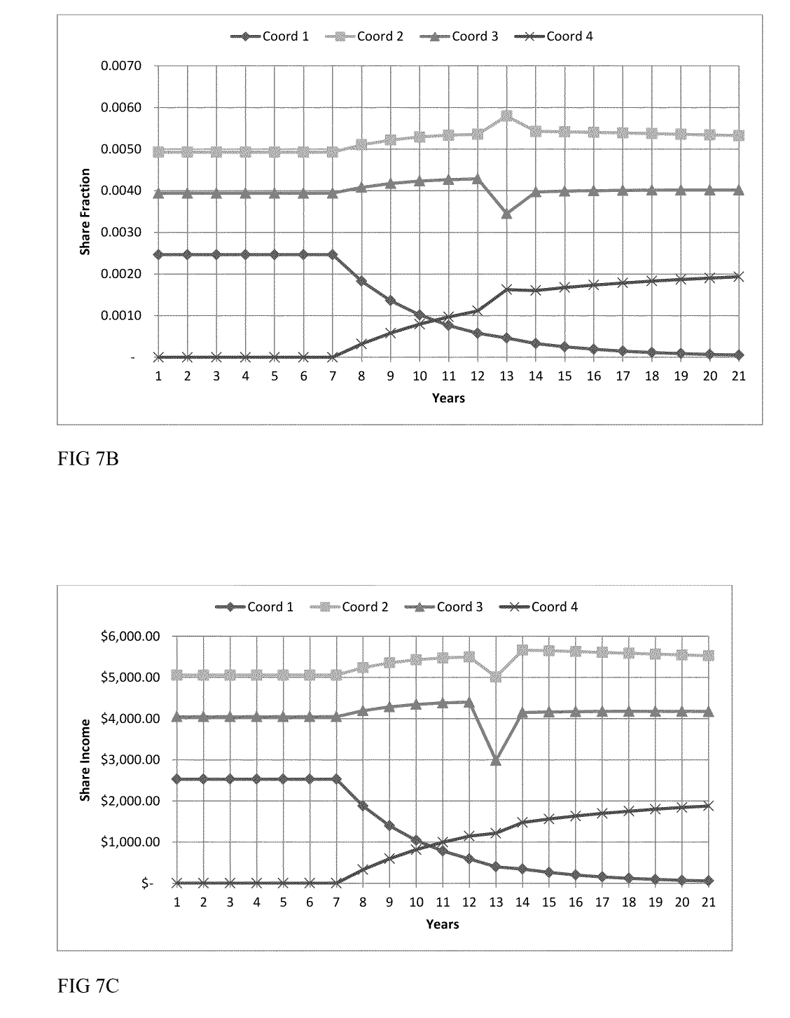

As a shared economy enhancement discussed at 2116 of “The Revenue Distribution Hierarchy” section, the Hierarchical Workspace System allocates shares at the RvF_{L} level or otherwise where shares are allocated at multiple levels, at the, RvF₄ to RvF_{L}, levels, to significant contributors to revenue generation. In these preferred embodiments, there is a franchise type arrangement in which Hierarchical Workspace (HWS) founders and investors collectively hold ½ of the shares (FIG. 7A) of each sector or service group utilising the HWS system and services. In these preferred arrangements, founders of sector or service groups collectively hold a fraction,

$${SF}_{f} ( = \frac{1}{6} ) ,$$

of the shares of their specific franchise group, while service coordinators within the franchise group collectively hold the remaining fraction,

$${SF}_{c} ( = \frac{1}{3} ) ,$$

of the shares of the group. In other embodiments the share allocations may deviate from these ½, ⅙, ⅓, values.

In preferred embodiments, each service coordinator's share fraction, of the collective service coordination shares, varies with his or her service coordination earnings accumulated over the lifetime of his or her service coordination duties, relative to collective service coordination earnings over the lifetime of the engagement of his or her group members. In other embodiments, the service coordinator's shares may be assessed over a defined long-term period, rather than over lifetimes of engagement.

Specifically, over a given sub-period, t, such as 1 year, each service coordinator, 1, with earnings, CI_{i,t}, is allocated a share income, CSI_{i,t}_{_{c}} (FIG. 7(1)), in the current sub-period, t_{c}, as a faction, CSF_{i,t}_{_{c}}, of the total project revenue, PV_{p,t}_{_{c}}, generated. This individual coordinator share fraction, CSF_{i,t}_{_{c}} (FIG. 7(2)), is a portion of the level L revenue fraction. RvF_{L}, that specifies the share income allocation for founders, investors, and coordinators, which is subdivided by the service coordinator's lifetime, τ, accumulated service coordination earnings within the group, relative that of the entire group of active and inactive service coordinators. However, for economic viability with the inevitable temporary and/or permanent cessation of individual service coordination activity, each inactive service coordinator's share value and consequently his or her share income depreciates exponentially in time (Examples 7(1, 2)). This depreciation rate is determined by the difference in the number of periods, t, between the current year, Y_{c}, of share value assessment and the last or end year, Y_{e,i}, of the service coordinator's engagement, but the exponential decay is accelerated by decreasing values of a parameter, μ. The value of this parameter, μ, is set by sector or service group managers. The service coordinators' share fractions are reassessed periodically at the end of a reporting period such as one year.

FIG. 7B shows the simulated share fractions, CSF_{i,t}_{_{c}}, while FIG. 7C displays share income, CSI_{i,t}_{_{c}}, of 4 service coordinators over a 21 year period for a work space hierarchy with comprehensive share fraction, RvF_{L}=0.034, a collective service coordination share fraction,

$${SF}_{c} = \frac{1}{3} ,$$

and with exponential decay parameter, μ=5. Here is specified Coordinator 1 earned $50,000.00 each year prior to his departure at the end of year 7. Coordinator 2 earned $100,000.00 each year, except for year 13 when she earned $120,000.00. Coordinator 3 earned $80,000.00 each year, but took a 1 year break in year 13, with a consequential 50% loss in total coordination earnings. Coordinator 4 joined the group in year 7 and earned $50,000.00 each year, except for year 13 when he earned $70,000.00.

### ACRONYMS

AEf—Frequency or repetitions, or otherwise fraction, associated with the execution of a unit of homogeneous activity
Af—Frequency or repetitions of a unit of homogeneous activity, required to constitute the activity
ALQE—Average of lower quartile ranked earnings
AM—Activity magnitude
ANf—Frequency or repetitions, or otherwise fraction, associated with the negotiation of a unit of homogeneous activity.
ASf—Frequency or repetitions, or otherwise fraction, associated with the supervision of a unit of homogeneous activity.
AStT—Standard time associated with the completion of a unit of homogeneous activity
AStW—Standard weight given to a unit of homogeneous activity
AW—Activity weight
CI—Coordinator's income
CNF—Coordinator number fraction facilitating service provider promotion
COL—Relative cost of living indicator of a region or country
CPV—Coordinator's personal project oversight value
CRvF—Coordinator's regionalised revenue fraction impaction their income
CRvF0—Coordinator's non-regionalised revenue fraction, which excludes cost of living considerations
CSF—Individual service coordinator's share fraction
CSI—Individual service coordinator's share income
CW1, CW2, CW3—Weights utilized in assessing coordinator's performance
DxMW—Mental dexterity weight assigned to a project activity
DxPW—Physical dexterity weight assigned to a project activity
DxW—Comprehensive dexterity weight assigned to a project activity
eTEF0—Error in assigning the preliminary task execution fraction
eTNF0—Error in assigning the preliminary task negotiation fraction
eTSF0—Error in assigning the preliminary task supervision fraction
ExMW—Mental aspect of the exertion weight assigned to a project activity
ExPW—Physical aspect of the exertion weight assigned to a project activity
ExW—Comprehensive exertion weight assigned to a project activity
IBEv—Subordinate's evaluation of a supervisor's performance
IEv—Internal evaluation of performance
IUEv—Supervisor's evaluation of subordinate's performance
LF—Shared level fraction
LQRR—Remuneration ratio for the lower quartile of earners,
LQW—Lower quartile weight
LW—Project to service listing weight
MCA—Minimum collaboration adherence
MCF—Minimum collaboration fraction
MCP—Minimum collaboration participation score
NC—Number of coordinators in the hierarchical workspace
NEH—Number of experts participants in historic projects
NELC—Number of experts currently listed
NLQ—Number of lower quartile ranked earners.
NNLC—Number of novices currently listed
NNLH—Number of novices listed in historic periods
NNRX—Maximum number of novice recruits
NPC—Number of projects currently listed
NPH—Number of historic projects
NR—Number of recruits
NSLC—Number of Service Providers listed currently
NWC—Number of weight categories utilized in assessing the standardized activity weights
OsV—Coordinator's personal project oversight value with work quality evaluation as added influence
PEI—Project execution income
PEI0—Project execution income that excludes cost of living considerations
PEW—Project execution weight
PEW1—Project execution weight, when LQRR=1.0 and PSvR=1.0
PNI—Project negotiation income
PNI0—Project negotiation income that excludes cost of living considerations
PNW—Project negotiation weight
PNW1—Project negotiation weight, when LQRR=1.0 and PSvR=1.0
PSI—Project supervision income
PSI0—Project supervision income that excludes cost of living considerations
PSvR—Project to service ratio
PSW—Project supervision weight
PSW1—Project supervision weight, when LQRR=1.0 and PSvR=1.0
PV—Project value, after expenses
PVC—Value of currently listed projects
PVH—Value of historic or done projects
QW—Weight assigned to the LQRR influence on PNW
RiW—Risk weight assigned to a project activity
RvF—Revenue fraction assigned to a given level of the hierarchy
RW—Weight assigned to LQRR influence on recruitment numbers
SF_{c}—Share fraction for the group of service coordinators
SF_{f}—Share fraction for the service group founders
SvEF—Service execution fraction which includes relative cost of living influences
SvEF0—Non-regionalised service execution fraction, which excludes relative cost of living influences
SvEV—Service execution value for service provider's performance evaluation
SvI—Service income or service provider income, which includes relative cost of living influences
SvI0—Non-regionalised service provider income
SvIF—Service income fraction, which includes relative cost of living influences
SvIF0—Non-regionalised service income fraction, which excludes relative cost of living influences
SvNF—Service negotiation fraction, which includes relative cost of living influences
SvNF0—Non-regionalised service negotiation fraction, which excludes relative cost of living influences
SvNV—Service negotiation value for service provider's performance evaluation
SvSF—Service supervision fraction, which includes relative cost of living influences
SvSF0—Non-regionalised service supervision fraction, which excludes relative cost of living influences
SvSV—Service supervision value for service provider's performance evaluation
SvV—Service value for service provider's performance evaluation
SW1, SW2, SW3, SW4, SW5—Weights utilized in evaluating service provider's performance
TEF—Task execution fraction
TEF0—Preliminary estimate of task execution fraction
TME—Targeted minimum earnings
TNF—Task negotiation fraction
TNF0—Preliminary estimate of the task negotiation fraction
TSF—Task supervision fraction
TSF0—Preliminary estimate of the task supervision fraction
WEv—Work or performance evaluation
Y_{c}—Current year
Yₑ—Year of last activity
XEv—External or client evaluation component of WEv
μ—Depreciation rate parameter for individual service coordinator's share fraction

### SUBSCRIPTS

α—Power of the level difference
a—Activity index number
β—Constant (>1.0), constraining the projecting negotiation weight
l—Level number, in the hierarchical workspace
L—Largest level number
P—Total number of projects
i—Service coordinator's index number
j—Service Provider's index number
n—Index number for evaluating supervisors
N—Number total for evaluating supervisors
m—Index number for evaluating subordinates
M—Number total for evaluating subordinates
p—Project index number
r—Economic region index number
t—Sub-period
t_{c}—Current or most recent sub-period
τ—Index number for a term or revenue generation period

The embodiments of the invention in which an exclusive property or privilege is claimed are defined as follows:

1. A computer implemented platform based customizable business process that facilitates service requesters, supports collaborating service providers and distributes revenue in a hierarchy, connected with the participation, integration and development these collaborators, through modules for: (i) revenue allocations in fractions that diminish progressively at levels for service provision, service coordination, operational funding and shareholding (ii) market intelligence guided controls on service provider recruitment (iii) service provider promotion, as assessed form their project income, work quality and collaboration adherence (iv) proportional compensation from service task fractions of project negotiation, supervision and execution weights (v) project negotiation, supervision and execution weights that evolve with project market changes (vi) project coordinator compensation based on their project oversight values and work quality.

2. A computer implemented customizable business process as defined in claim 1 in which in preferred embodiments, service providers and service coordinators operate in geo-fenced groups, bound by geography and service sector, while in other embodiments these service providers and service coordinators operate in geo-neutral groups, bound only by service sector.

3. A computer implemented customizable business process as defined in claim 1, in accordance with modules (FIGS. 1, 2, 3, 4, 5, 6, 7) of the customizing algorithm provided for revenue allocation to hierarchy levels and for service provider recruitment, service provider promotion, service provider compensation, project sourcing incentives and service coordinator compensation.

4. A computer implemented customizable business process as defined in claim 1 in which revenue is conserved in its distribution through the platform based hierarchy, as this revenue is allocated in proportions that diminish progressively from the level for service provision to levels for service coordination, operational funding and shareholding, even with any configured increase or decrease in the number of levels.

5. A computer implemented customizable business process as defined in claim 1 in which service providers are recruited from qualified applicants from a mix of project needs, competition and queuing, as justified by the likelihood of recruits to receive adequate income, which is assessed from project adequacy and from the service incomes of lower ranked earners relative to a test or target value.

6. A computer implemented customizable business process as defined in claim 1 in which participating service providers can be promoted to service coordinator positions, but this promotion is conditional on average coordination income exceeding average service provision income, as assessed from an interconnected relationship between the number of coordinators of multiple projects, the number of service providers and the relationship between revenue fractions at the service provision and the project or service coordination levels.

7. A computer implemented customizable business process as defined in claim 1 in which the service provider's eligibility for promotion is decided by his/her superior weighted average of moderated income, generated in their negotiation, supervision and execution roles, this moderation influenced by the service provider's adherence to minimum collaboration requirements and by their quality of work, encapsulated in their service values.

8. A computer implemented customizable business process as defined in claim 1 in which the compensation is for fixed-price service provision, which is assessed from the service provider's service negotiation, supervision and execution fractions of corresponding project negotiation, supervision and execution weights; the fractions incorporating relative regional cost of living as a spending equity provision.

9. A computer implemented customizable business process as defined in claim 1 in which in preferred embodiments, service provision consumes at least two-thirds of the fixed-price project value after expenses, of which after project negotiation earnings are deducted the project supervision role utilizes up to one-third of the remaining value, nevertheless in other less favoured embodiments these rules for two-third minimum and one-third maximum can be avoided.

10. A computer implemented customizable business process as defined in claim 1 in which an aspect of the assessment of service provider compensation involves the use of project negotiation, supervision and execution weights, that evolve to incentivise project sourcing and development where, as the project negotiation weight increases exponentially towards a prescribed maximum with increasing project scarcity and/or with decreasing service incomes, its project supervision and execution counterparts, seamlessly undergo compensatory proportional adjustments.

11. A computer implemented customizable business process as defined in claim 1 in which, within each franchise or sector group of participants, service coordinators are collectively allocated a proportion of the group's shares, from which each service coordinator's service coordination share fraction is based on his or her accumulated earnings relative to that of his or her colleagues in their service or sector group.

12. A computer implemented customizable business process as defined in claim 1 in which, service coordinators within each franchise or service group of participants, are collectively allocated service coordination shares, from which each service coordinator's share fraction varies with his or her lifetime service coordination earnings, relative to the lifetime service coordination earnings of all previous and current service coordinators, with any given individual service coordinator's share faction depreciating exponentially with increasing departure from the last period or end date of his or her earnings.

13. A computer implemented customizable business process as defined in claim 2 in which, in preferred embodiments the geo-fenced and geo-neutral groups generate and manage their own operating fund and shareholding entitlements, in compliance with hierarchical workspace agreements, while in other embodiments these funds can be centrally managed.

14. A computer implemented customizable business process as defined in claim 4 in which in preferred embodiments, the revenue proportion(s) associated with an additional or fifth level or any number of additional levels, serve only to augment the shareholding allocation or the operational funding, while in other less favoured embodiments higher level managers are added when levels are added, and in yet other less favoured embodiments revenue proportions are skewed to enhance the upper level or lower level values.

15. A computer implemented customizable business process as defined in claim 5, in which the targeted value for minimum earnings influencing recruitment, relates to a minimum collaboration fraction of project work prescribed for service provider disbursement to lower earning-ranked service providers or colleagues in their service or sector group.

16. A computer implemented customizable business process as defined in claim 8 in which the service negotiation, supervision and execution fractions are founded on standardized time-based extensions of standardized value-ranked activities, the latter assessed from physical and mental requirements in the dexterity, risk and exertion, categories with options for adding other categories for this assessment.
